(19) United States
(12) Patent Application Publication
(10) Pub. No.: US 2013/0124299 A1
(43) Pub. Date: May 16, 2013

(54) Optimizing Communication of Content Through Networked Media

(71) Applicants: Gerard J. Montgomery, Advance Mills, VA (US); Richard S. Okin, South Orange, NJ (US)

(72) Inventors: Gerard J. Montgomery, Advance Mills, VA (US); Richard S. Okin, South Orange, NJ (US)

(73) Assignee: Epic Media Group, INC., New York, NY (US)

(21) Appl. No.: 13/605,627

(22) Filed: Sep. 6, 2012

Related U.S. Application Data
(60) Provisional application No. 61/531,385, filed on Sep. 6, 2011.

(51) Int. Cl. G06Q 30/02

(52) U.S. Cl. CPC G06Q 30/0244
USPC 705/14.43

(57) ABSTRACT

Methods and systems for identifying content to customers are disclosed. One embodiment provides a method for identifying at least one piece of content to communicate to a consumer comprising receiving impression request data associated with consumers accessing a networked medium in a computing environment, employing a parse request module to evaluate campaign constraints to generate candidate plans, wherein each of the candidate plans includes variable having an associated weight and campaign constraint, employing an optimization engine to determine a first score for each of the candidate plans using a model, wherein the model utilizes precomputed data and the impression request data, and for applying real-time yield management algorithm to evaluate the variable and the campaign constraint to develop a second score for each of the candidate plans, and identifying an optimum plan based on the first score and the second score.

### CROSS REFERENCE TO RELATED APPLICATIONS

This application claims priority to U.S. Provisional Patent Application No. 61/531,385, entitled “Optimizing Communication of Content Through Networked Media,” filed Sep. 6, 2011, the entirety of which is hereby incorporated by reference.

### FIELD OF THE INVENTION

Embodiments of the invention described herein generally relate to techniques, strategies, tools, methods, and systems for collecting, processing, and analyzing data in association with communicating advertising content and other marketing information through networked media.

### BACKGROUND

Many companies are faced with the challenge of finding the best way to select the most relevant and ultimately most profitable content to deliver to consumers through networked media and other browser-based environments, such as the Internet.

For example, many conventional advertisement serving platforms rely on human interaction and/or a manual weighting system to develop the plans required to drive the delivery of appropriate advertisements to consumers. In the process of serving advertising content, these platforms typically do not adequately account for yield management factors such as scarcity, budget, or time horizon, for example. Such platforms are also usually inefficient and not scalable, while often employing overly simplistic statistical modeling techniques. Many conventional platforms and systems do not support comparison testing to determine the effectiveness of different plans with identifying and delivering advertising content. In addition, most conventional systems cannot maintain the level of data preprocessing speed required to keep pace with the volume of traffic typically received in response to an Internet-based advertising campaign.

In view of the above-described issues, enhanced tools and techniques are needed to identify and deliver advertising content more effectively and efficiently through networked media.

### BRIEF DESCRIPTION OF THE FIGURES

The utility of the embodiments of the invention will be readily appreciated and understood from consideration of the following description of the embodiments of the invention when viewed in connection with the accompanying drawings, wherein:

FIGS. 1A and 1B schematically illustrate an overview of an example of a system and process architecture for an advertising optimization system;

FIG. 2 includes a matrix illustrating examples of the types of data that may be associated with different types of visitors;

FIG. 3 illustrates an example of node traffic data that may be expected for processing through an advertising optimization system;

FIG. 4 illustrates an example of a model that may be generated and executed in accordance with various embodiments of the invention;

FIG. 5 includes examples of model variables that can be employed in developing and generating different models;

FIG. 6 illustrates examples of anonymous data variables;

FIG. 7 illustrates examples of data that can be derived from user agent strings;

FIG. 8 includes examples of referrer data;

FIG. 9 includes examples of ZIPS appends;

FIG. 10 includes examples of visitor behavior data;

FIG. 11 includes examples of registered individual appends;

FIG. 12 includes a table illustrating examples of plan factor weights that can be used in association with applying weights to various candidate plans;

FIG. 13 illustrates an example of an RTYM process score computation;

FIG. 14 illustrates examples of RTYM scores by RTYM factors;

FIG. 15 illustrates examples of RTYM score factors by plan;

FIG. 16 schematically illustrates one example of a process and system architecture for scoring an offer or plan;

FIG. 17 illustrates an example of processing multiple variants or different versions of plans through an optimization engine;

FIG. 18 includes an example of a plan profiler report;

FIG. 19 identifies combinations of factors and their corresponding impact on click and conversion rates;

FIG. 20 illustrates an example of a decision tree structured in connection with a plan profiler tool;

FIG. 21 illustrates an example of a variable importance screen; FIG. 22 illustrates an example of a mosaic chart screen;

FIG. 23 includes an example of an advertiser profiler report; FIG. 24 includes an example of a decision tree screen;

FIG. 25 includes an example of a variable importance screen;

FIGS. 26 through 29 include examples of optimization engine rates reports;

FIG. 30 includes a summary of results associated with a performance assessment for the optimization engine;

FIG. 31 illustrates examples of performance details for the optimization engine;

FIG. 32 illustrates an example of a report that can be generated for a campaign manager; and

FIG. 33 illustrates an example of a model quintile report.

### DETAILED DESCRIPTION

In various embodiments, the invention provides tools, strategies, and techniques for identifying and communicating content such as advertising content or other marketing information, for example, to consumers through a computing environment or a networked medium. The inventors have developed ways to leverage insights gathered from various data sources to optimize the process of determining relevant and/or profitable content including advertisements, for example, to serve to consumers through a networked medium (e.g., the Internet). In certain embodiments, the invention may also take into account yield management factors such as scarcity, budget, time horizon, and many other factors.

As applied herein with respect to various embodiments of the invention, the term “content” may include various content presented through networked media, such as advertising content, marketing information, interactive screen displays, games, photographs, text directions, or many other types of content communicated to consumers. It will be appreciated that advertising content of various kinds have been described herein for convenience of illustrating one type of content.

As applied herein with respect to various embodiments of the invention, the term “impression” may include any opportunity to view, select, access, or otherwise interact with content. Examples of “impressions” may include a click through event with respect to advertising content, directing a user to a landing page, playing a video, viewing a photograph or graphic, hovering over an interactive advertisement with an access device (e.g., a pointer), or many others.

The inventors appreciate that behavioral and other methods of targeting are rapidly becoming a competitive necessity for online advertising. An important objective is to provide the most effective targeting capability available in a cost-effective and low-risk manner. In various embodiments, the optimization engines described herein can be programmed to select advertisements for user impressions that maximize click and conversion rates; net revenue; advertiser leads, revenue and satisfaction; and publisher revenue and satisfaction. To deal with the complexities of these sometimes competing goals, the optimization engine can use advanced statistical models and yield management algorithms. In addition, user interfaces and reporting can be provided for campaign managers and other operational managers to assist with the optimizing process based on their knowledge and expertise. In certain embodiments, the optimization engine may be readily integrated into an existing advertising server and/or data warehouse infrastructure.

As described in more detail below, in various embodiments an optimization engine (sometimes referred to herein as “OE”) can be provided for assisting with identifying and communicating optimum advertising content or other marketing information to consumers. The optimization engine can be configured to readily incorporate new and changing data sources, data regulations, or new models (e.g., algorithms that predict the success of a given advertising plan) without requiring changes to the underlying software code or other programming instructions employed in the engine. In this respect, the optimization engine may be programmed to be platform agnostic thus requiring minimal integration efforts with other systems or data sources. In certain embodiments, the invention offers a “black box” system for optimization which may include a self-contained set of software code (e.g., Java code) with defined inputs and outputs that support the ability of the optimization engine to function as a black box with respect to its operating environment.

For example, if a calling system specifies the inputs correctly and is capable of receiving the output data, then the calling system does not require any other substantial knowledge of how the optimization engine operates. In this manner, the optimization engine can be programmed to be agnostic to source systems and areas to be optimized. For example, the optimization engine may be operatively associated with a repository updater that establishes connections with new data sources by creating basic ETL (extraction/transformation/load) processes that map the new data sources to either existing or new data structures that can then be consumed by an auto modeler. The repository updater can leverage the flexibility of the underlying data model which may possess characteristics native to most relational database systems.

In various embodiments, the optimization engine functions as a real-time online component that facilitates advertising plan scoring for maximizing click and conversion rates, for example, for browser-based advertising through networked media. The optimization engine may also be employed in connection with other computing environments, applications, or devices, such as applications accessed on electronic tablets, applications accessed through mobile devices (e.g., mobile phones), or other software or devices into which aspects of the optimization engine can be integrated. The optimization engine may also work cooperatively with real-time yield management (“RTYM”) data components, algorithms, or processes to assist with efforts to maximize profit, return on investment, advertiser success, and/or publisher satisfaction. The optimization engine can promote testing of new models and data sources against one another in an automated manner, while limiting the necessity for involvement of human interaction as much as possible at each stage of the process. By interacting with RTYM components, the optimization engine can address the need to understand and apply certain factors such as scarcity of inventory, budget, time available, margin, priority, or many other yield management related factors. The optimization engine may calculate a score associated with one or more RTYM components.

For example, in one embodiment, the optimization engine ties statistical data to an impression of a particular piece of content. Given an IP address, the optimization engine identifies the zipcode associated with the IP address. The optimization engine in such an embodiment then accesses census data for that zip code and utilizes that census data to determine what content to serve. For instance, a particular advertiser may be interested in targeting a particular economic band. By identifying the census data, the optimization engine is able to determine the economic band of a user associated with a particular IP address and serve an ad targeted to that economic band in real time. Such associations can also be varied in real time within particular models or used in conjunction with other associations to vary an overall campaign or to vary the constituent parts of a campaign.

In operation, the optimization engine may be programmed with the ability to use multiple types of modeling techniques, including linear regression, logistic regression, artificial intelligence based models, neural networks, vector type algorithms, and many others, while also supporting models that feed other models (e.g., a model-of-models approach). In certain aspects, the optimization engine can be employed to fully automate the process from data processing to model deployment, and it may accomplish certain tasks through a combination of an offline analytic tools or processes and online (e.g., open source) modeling software. The optimization engine may be programmed to utilize processes that perform data “sanity checks” and other statistical methods for data analysis, and may be programmed to swap out one model for another model in real-time, including facilitating deployment of new models to limited nodes for additional sanity checking prior to full deployment. The optimization engine may also be programmed with the capacity to test multiple versions of a software code base, in addition to multiple versions of different plans or models, against one another for optimization purposes. The deployment model and underlying data collection structures operatively associated with the optimization engine can be designed to allow various combinations of models and code versions across multiple nodes.

In various embodiments of the invention, the repository updater can be configured to compute a variety of statistics or other data that can be loaded into a look-up table, for example, for use by the models of the optimization at runtime to score and select the best advertising content. The repository updater may employ periodic (e.g., nightly) enterprise data warehouse (“EDW”) processing to update online data and/or to create or recreate various models. It can be appreciated that the optimization engine can make use of historical data that is available in the data warehouse by precomputing statistics that are available in real time when determining which advertisement will likely perform the best. By leveraging many useful statistics that are made available at the time of model execution, this precomputing activity offers a level of data processing that can support enhanced decision speeds and transaction rates.

In certain embodiments, the inventors have developed ways to automate the creation of new optimization strategies. The optimization strategies may use various modeling processes for predicting behavior that can be represented in an understandable format on which human decisions can be based. For example, the optimization engine can be configured to function in cooperative association with a yield management control center (“YMCC”) which can provide campaign managers or other marketing personnel with actionable insights. These insights can be presented in the form of a variety of reports such as optimization engine performance reports, plan profiler reports, advertiser profiler reports, or many others, as described below in more detail.

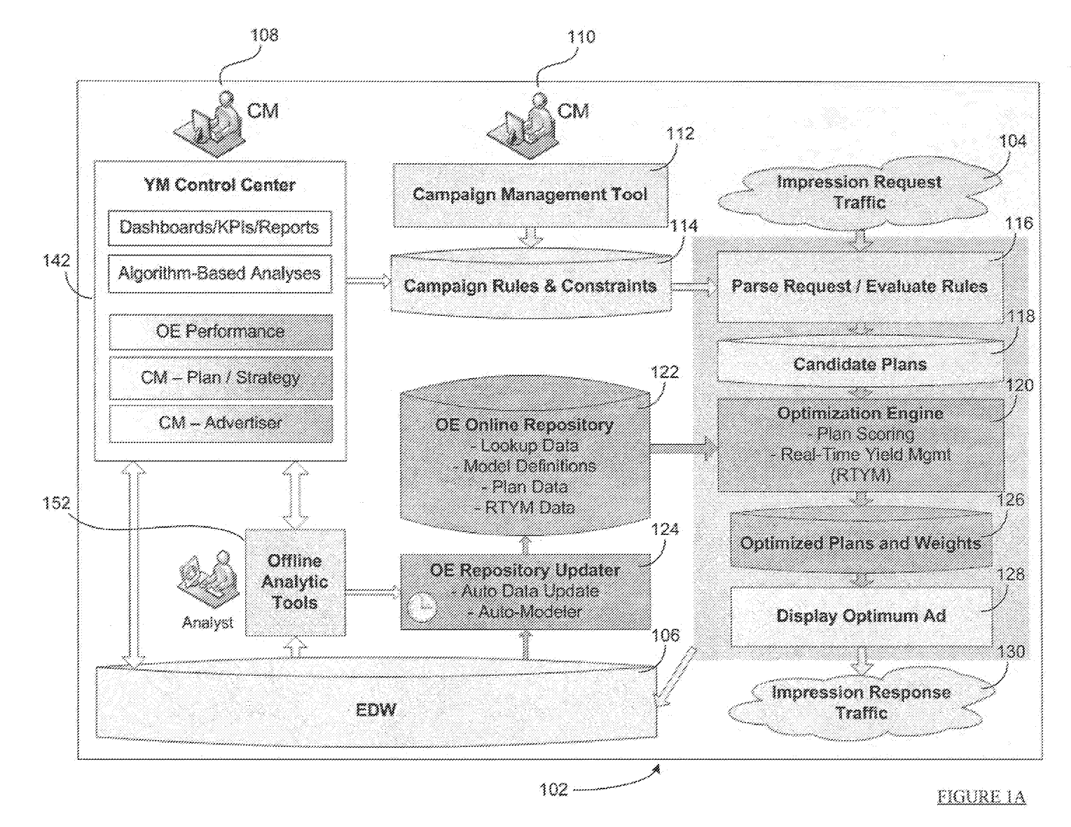

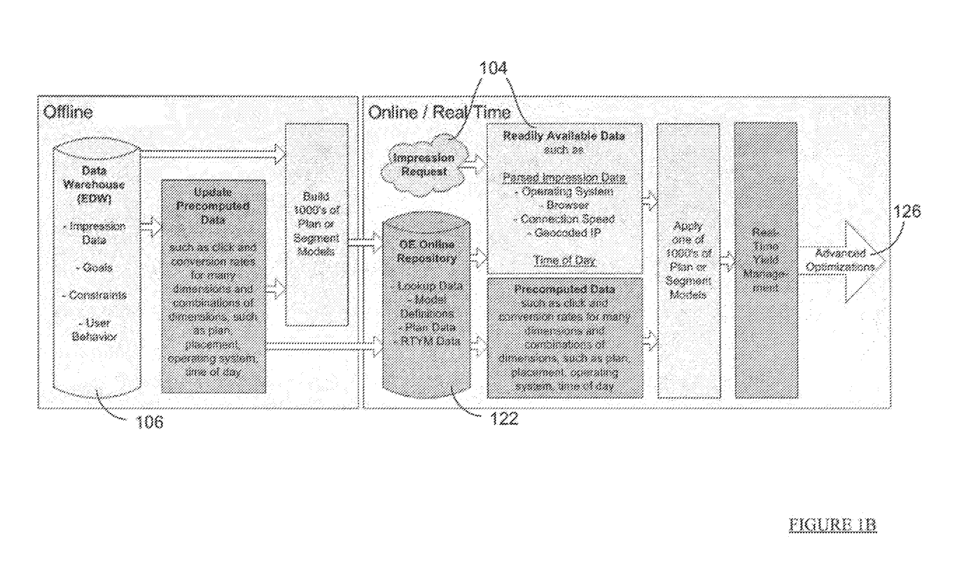

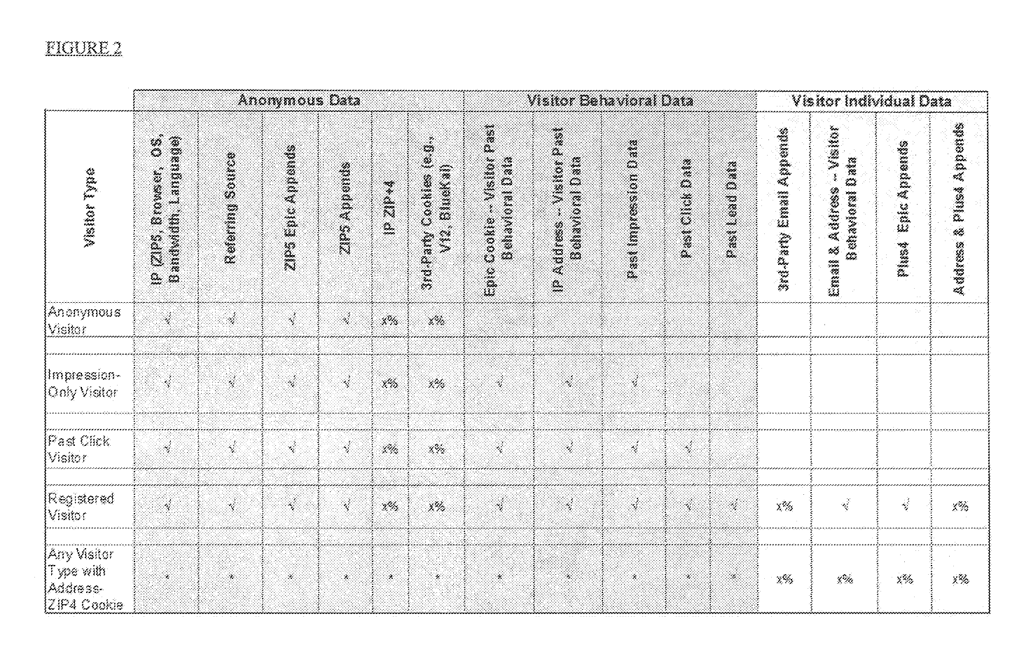

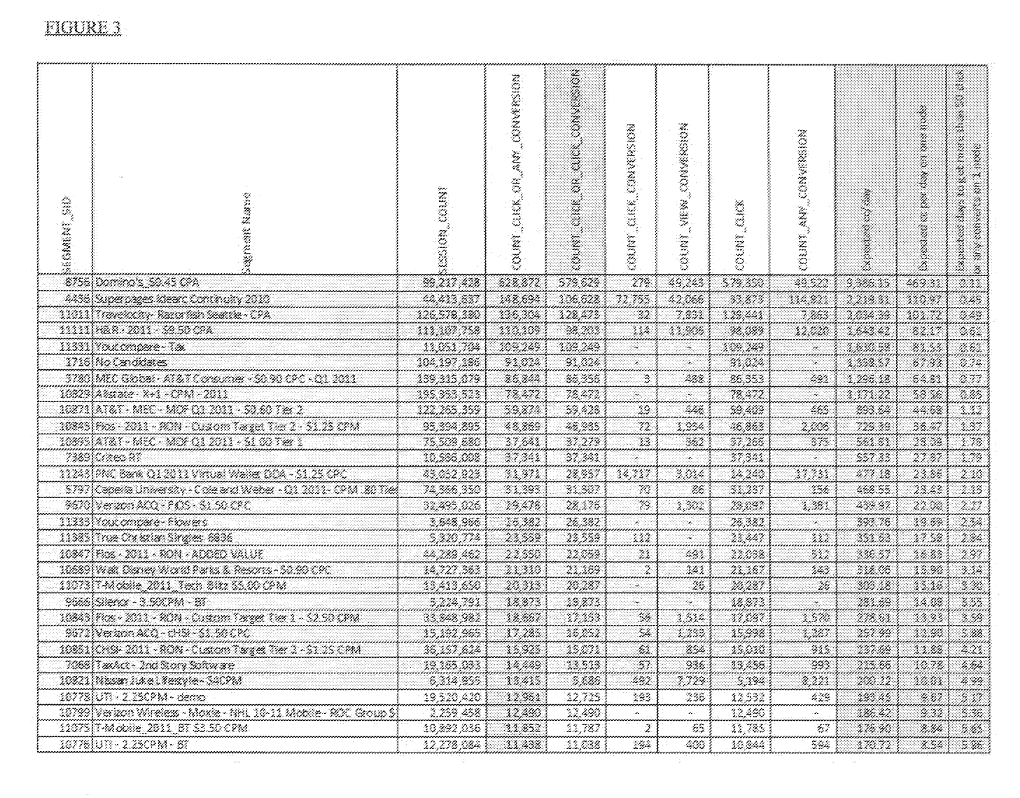

FIGS. 1A and 1B schematically illustrate an overview of an example of a system and process architecture for an optimization system 102 structured in accordance with various embodiments of the invention. The system 102 may be employed within an environment for processing, analyzing, and communicating data related to delivery of advertising content to various consumers in a browser-based or networked computing environment. As shown, various kinds of impression request traffic related data 104 may be received for processing by the system 102. Those skilled in the art can appreciate that the impression request traffic related data 104 may be associated with one or more consumers accessing a networked medium with a browser-based software, for example, and viewing, clicking, clicking through, or otherwise accessing communicated advertising content or other marketing information. For example, the impression request traffic data 104 may be associated with a consumer visiting a web site with a browser wherein the consumer selects an advertisement displayed on the web site. The consumers may be characterized as one or more visitor types with respect to offers made in association with advertising content and how the consumers responded to the offers: anonymous visitor (no previous information known about visitor); impression-only visitor (impression data available from a previous visit, but no clicks made in response to an offer or advertisement); past click visitor (visitor clicked on a previous offer); a registered visitor (visitor registered for a previous offer); or abandoned form visitor (visitor abandoned a registration process, for example, after providing email and/or address information). FIG. 2 includes a matrix illustrating examples of the types of data that may be associated with different types of visitors.

At least part of the input data associated with the impression request traffic data 104 may include data associated with the browser software of the consumer. This browser associated data may include, for example, IP address, referrer data, user agent information, cookie data, or other data that can be translated into geographic data, language, time of day, topics, frequency cap, channel, spot, publisher, or others. In certain embodiments, additional input data may be derived from an enterprise data warehouse 106, or another suitable data source, for access and use by the system 102. Other data sources may include social media data (e.g., Twitter or Foursquare), “Hitwise” data, “comScore” data, online transaction data from other sources, offline transaction data from other sources, or client-available online or offline data such as lead conversion or purchase transactions. FIG. 3 illustrates an example of node traffic data that may be expected for processing through the system 102.

It can be seen that one or more campaign managers 108, 110 may be involved in the development and execution of different plans that govern delivery of a given advertisement to a web site or other media for viewing and access by consumers. For example, the campaign manager 110 may access a campaign management tool 112 which may be embodied, for example, as a software program providing a user interface for manipulating different aspects of a plan. The campaign management tool 112 may be used to specify one or more campaign rules or constraints 114, as well as potentially one or more weights associated with variables or other factors included in the plan. For example, plans may be excluded or included for presenting advertisement content to a consumer based on target attributes such as date, time, publisher, frequency cap, advertisement dimensions, or other constraints. In one example, a constraint may be to show each available advertisement or offer a predefined number of times specified for a given advertisement within a given time period. During operation, the system 102 may employ a parse request module 116 to evaluate the campaign rules and constraints 114 to generate one or more candidate plans 118. The candidate plans 118 may be sorted based on their weights and stored in an appropriate data storage medium. The constraints may be hard constraints that cannot be changed or soft constraints that can be modified under some circumstances.

In various embodiments, an optimization engine 120 may be programmed to generate one or more scores for each of the one or more candidate plans 118 using one or more statistical models and/or one or more real-time yield management (“RTYM”) algorithms. For each of the candidate plans 118, the optimization engine 120 may execute one or more mathematical equations or statistical models based on various data sources. In various embodiments, the models may be generated based on data obtained from the impression request traffic related data 104, which may include referrer data, time of data, or user agent data, for example, among other data. In certain embodiments, the optimization engine 120 may access data stored in an online repository 122, which may include precomputed data or statistics, model definitions, plan data, and/or RTYM data, to generate or execute one or more models. The models may be generated or executed by employing linear regression analysis, logistic regression analysis, neural networks, artificial intelligence based systems, vector type algorithms, or a variety of other types of statistical techniques.

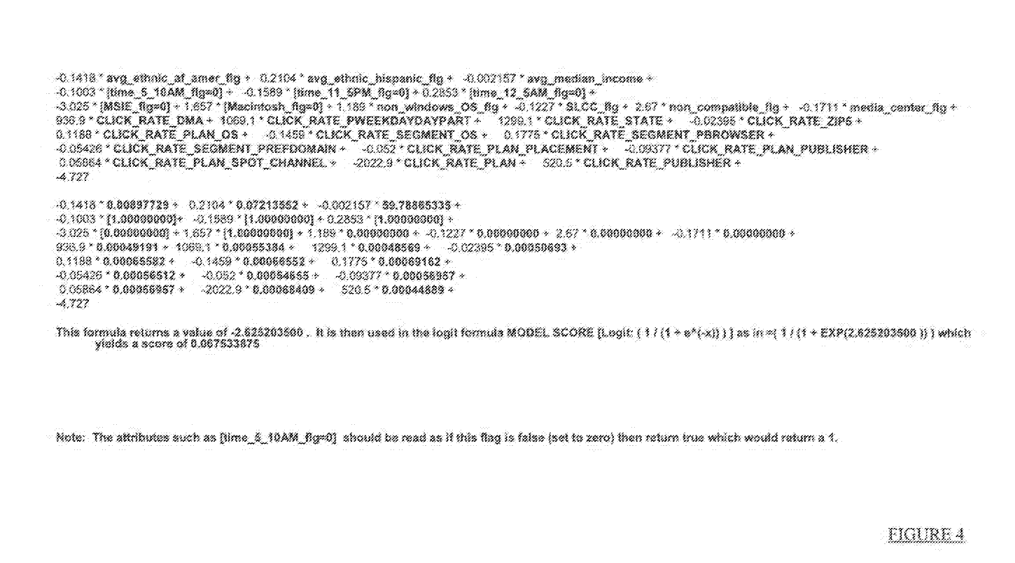

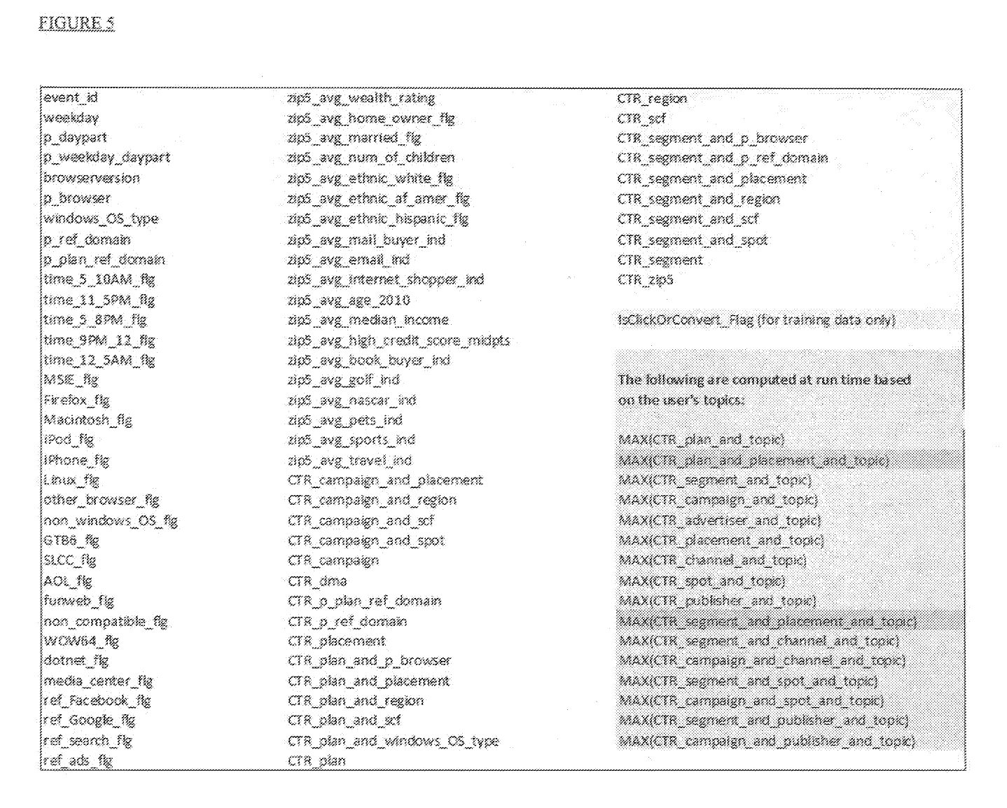

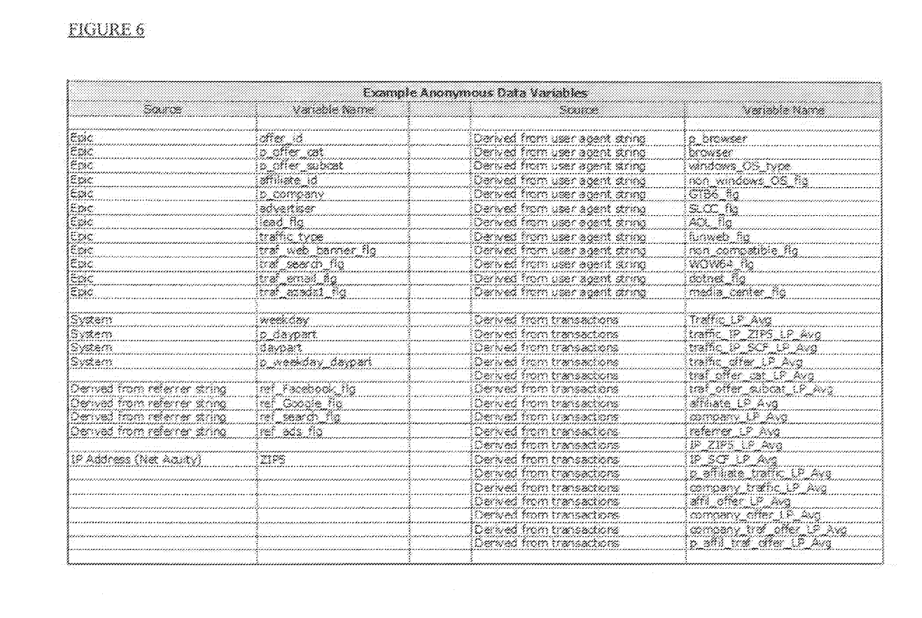

FIG. 4 illustrates an example of a model that may be generated and executed in accordance with various embodiments of the invention. The model may employ data drawn from the enterprise data warehouse 106 and/or the online repository 122. The data may be extracted using a data mining (DM) tool, such as the open source project WEKA. The data may be loaded into an analytical modeling tool, such as, for example, SPSS (originally, Statistical Software for the Social Sciences) software or other analytical modeling tools. Next, in this example, a step wise regression can be performed to determine which variables are best suited for each plan 118. Algorithms or mathematical models can then be created for each plan 118. As described herein, the models may then be loaded into an advertisement serving platform along with one or more supporting look-up tables. In the example shown in FIG. 4, a model generated for Plan 29849 is illustrated. FIG. 5 includes examples of model variables that can be employed in developing and generating different models.

In various embodiments, the optimization engine 120 may implement models based on user-level data. For example, precomputed data may include user-specific data based on transaction history (e.g., sites visited, advertisements clicked, or conversions) and these data may be applied in the models at the time of impression. In certain embodiments, the models can be developed by improving the preprocessing of topic, user agent, referrer, keyword and other data; implementing segment and category level models; taking advantage of user advertisement frequency data; implementing model confidence scores; and/or evaluating alternative data mining algorithms.

The online repository 122 may retrieve data stored within the enterprise data warehouse 106, for example, among other potential data sources. The online repository

122 may include one or more look-up data tables that can be used in connection with scoring the different candidate plans 118. The online repository 122 may be operatively associated with a repository updater 124 that can be programmed to perform updates and/or modeling of data obtained from the data warehouse 106. The data updates and/or data model generation may be automated by the repository updater 124. Statistical data extracted from the enterprise data warehouse 106 may include click-through response (“CTR”) data; placement related data, campaign data, spot data, append data, or other data. For example, append data may include precomputed statistics obtained by the optimization engine 102 from the online repository 122 which are appended and used in association with model generation and/or execution. Examples of precomputed data include click and conversion rates for multiple dimensions and combinations of dimensions, such as plan placement, operating system, and/or time of day, among many others. Other examples of data stored in the online repository 122 include plan statistics; topic statistics; publisher data; spot data; placement statistics; past visit data; ZIPS data; demographics; customized or derived append data; data stored at the ZIP code level such as income, marital status, or ethnicity; audience segment data; consumer database appends; email reverse appends; and/or, third-party cookie data making use of available physical address-level appends.

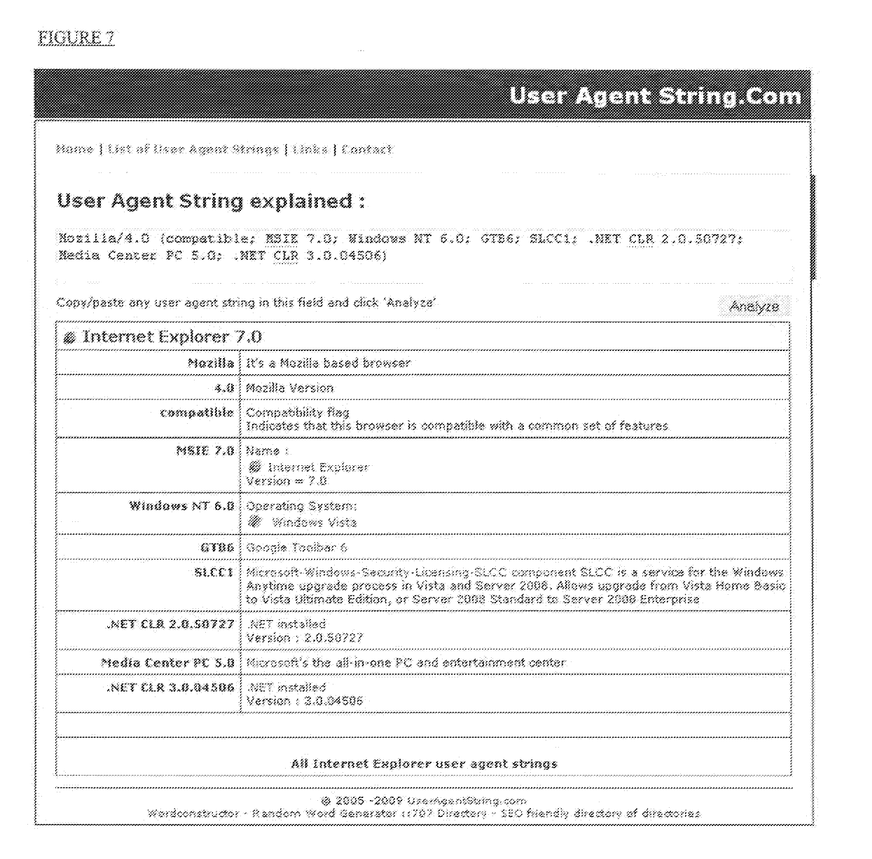

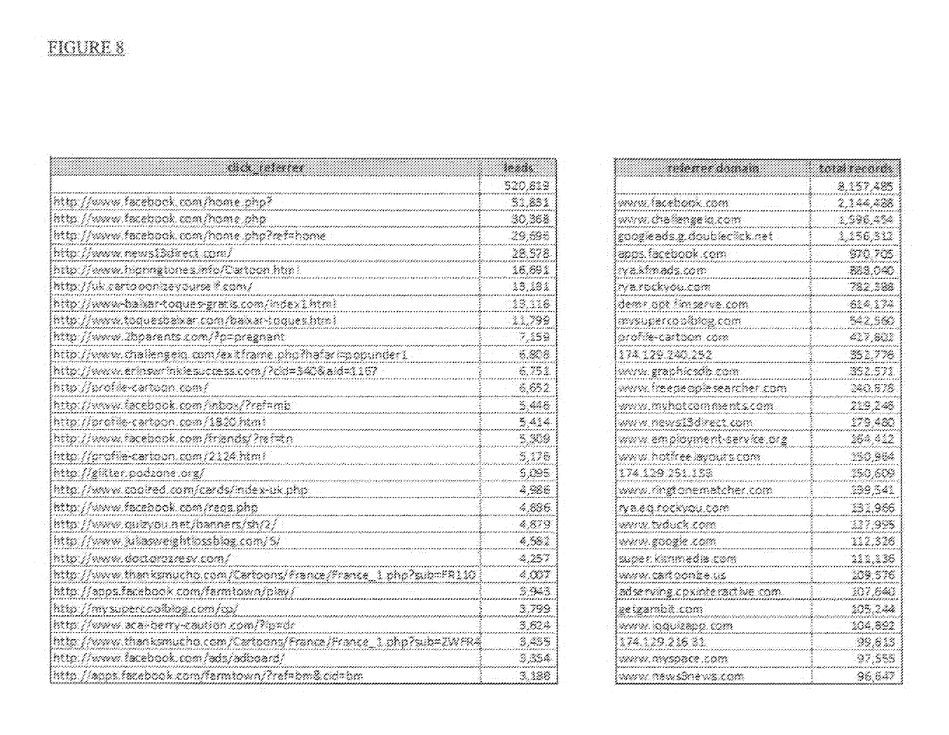

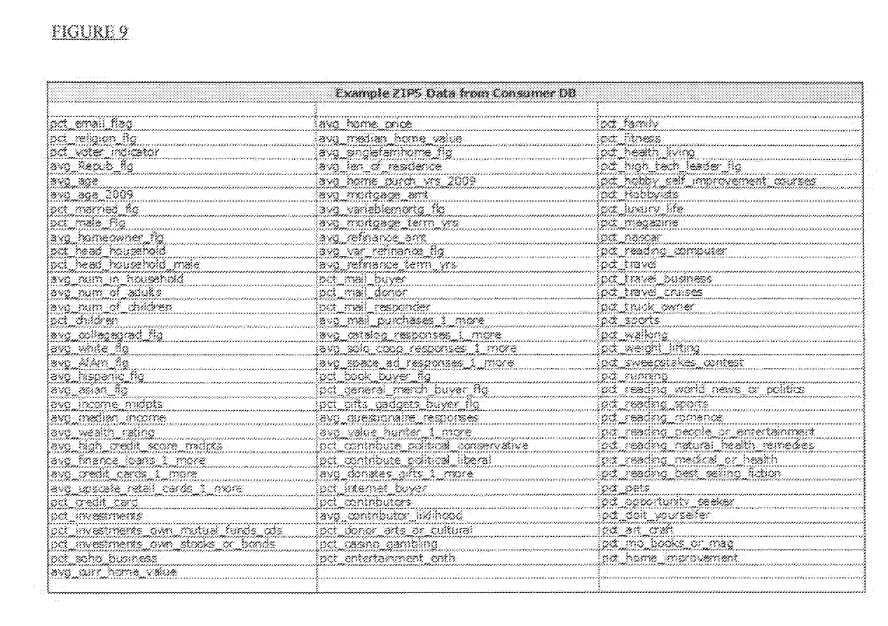

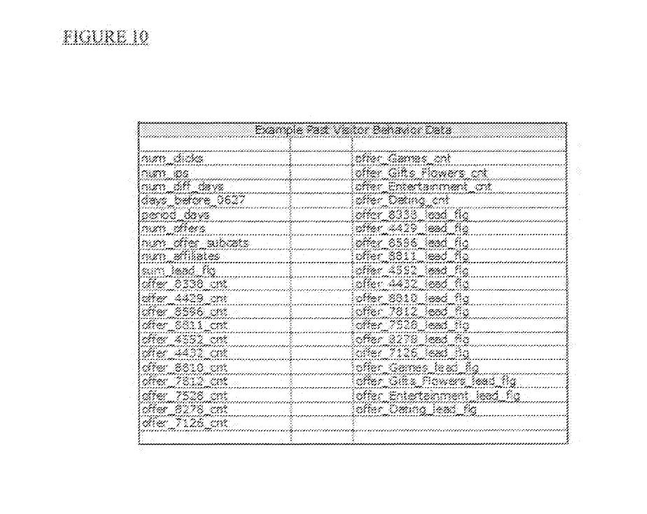

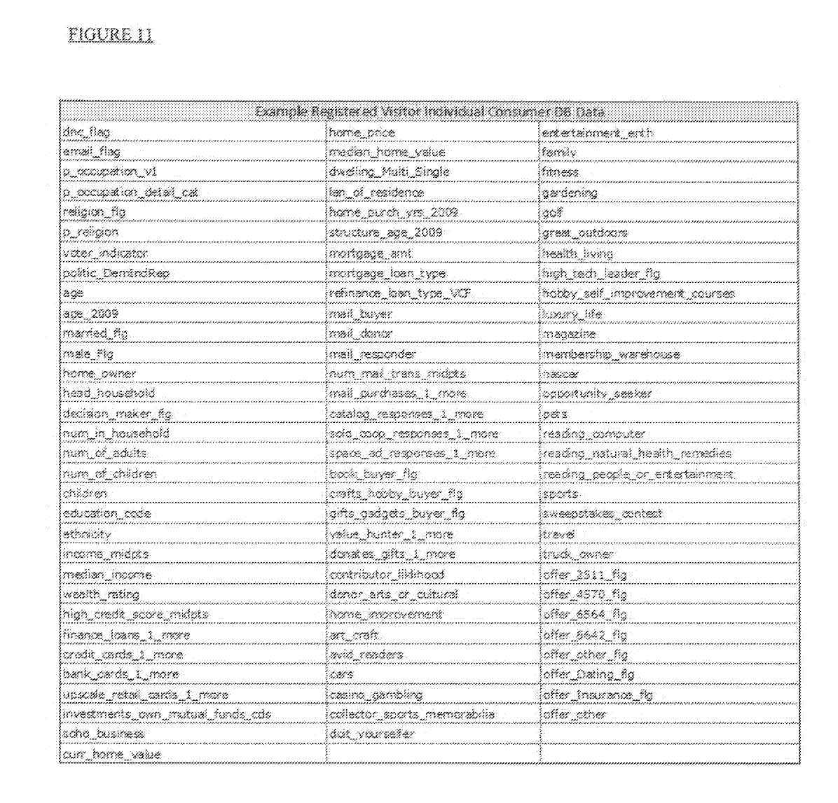

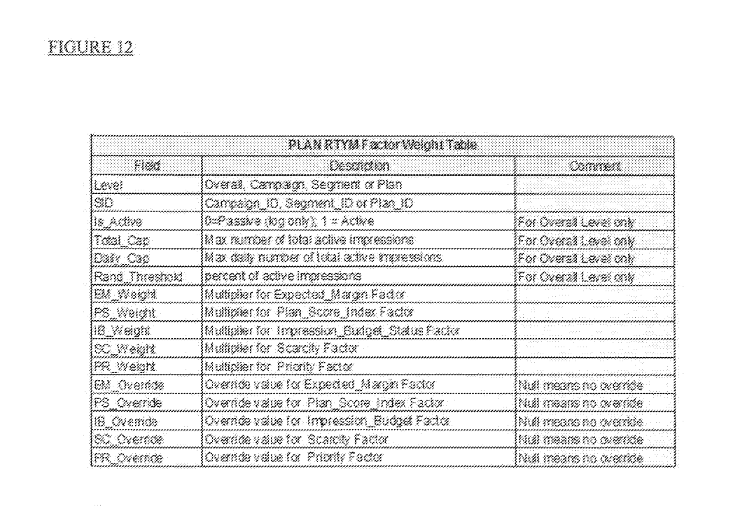

FIGS. 6 through 11 include examples of various data that may be used in connection with analyses, model generation, or algorithms as employed in connection with various embodiments of the invention. FIG. 6 illustrates examples of anonymous data variables. FIG. 7 illustrates examples of data that can be derived from user agent strings. FIG. 8 includes examples of referrer data. FIG. 9 includes examples of ZIPS appends. FIG. 10 includes examples of visitor behavior data. FIG. 11 includes examples of registered individual appends.

In various embodiments, the optimization system 102 may perform automated model updates by executing real-time updates to key data tables used by different models, including data stored in the online repository 122, for example. Examples of these data include offer click through rates and lead conversion statistics, relevant publisher statistics, user agent data, and/or referrer domain statistics. Such updates may include automated updates to different tables used by different models (e.g., on a daily, weekly, or anther periodic or non-periodic basis). Likewise automated model updates (e.g., daily, weekly, or another periodic or non-periodic basis) may be performed with the updated data with regard to the various modeling algorithms employed within the system 102. In certain embodiments, the repository updater 124 may facilitate these automated data and model updates by maintaining SQL scripts, for example, that regenerate look-up data and model development training or test tables in the online repository 122. The repository updater 124 may track plan averages and standard deviations for click and action scores, plan impressions, and/or plan opportunities (e.g., number of times in a candidate list). In certain embodiments, the repository updater 124 may be programmed for sessionization or assigning one session identifier to all impressions that share the same user, IP, user agent, plan, and placement, and that occur within a predetermined period of each other (e.g., 30 minutes); matchback by associating one click or conversion (e.g., event_type_sid 2 or 6) with each session, preferring conversions; computing various rates; sampling by selecting all clicks/converts and obtain a sample for non-clicks/converts; and/or, creating training data for enhancing system 102 performance.

It can be appreciated that update or generation activity performed in connection with various functions of the optimization engine 120, or data employed within the system 102, can be performed on a periodic basis (e.g., hourly, daily, nightly, weekly, or with another frequency), on a non-periodic basis, on a real-time or near real-time basis, subject to a predetermined triggering event, or any other basis.

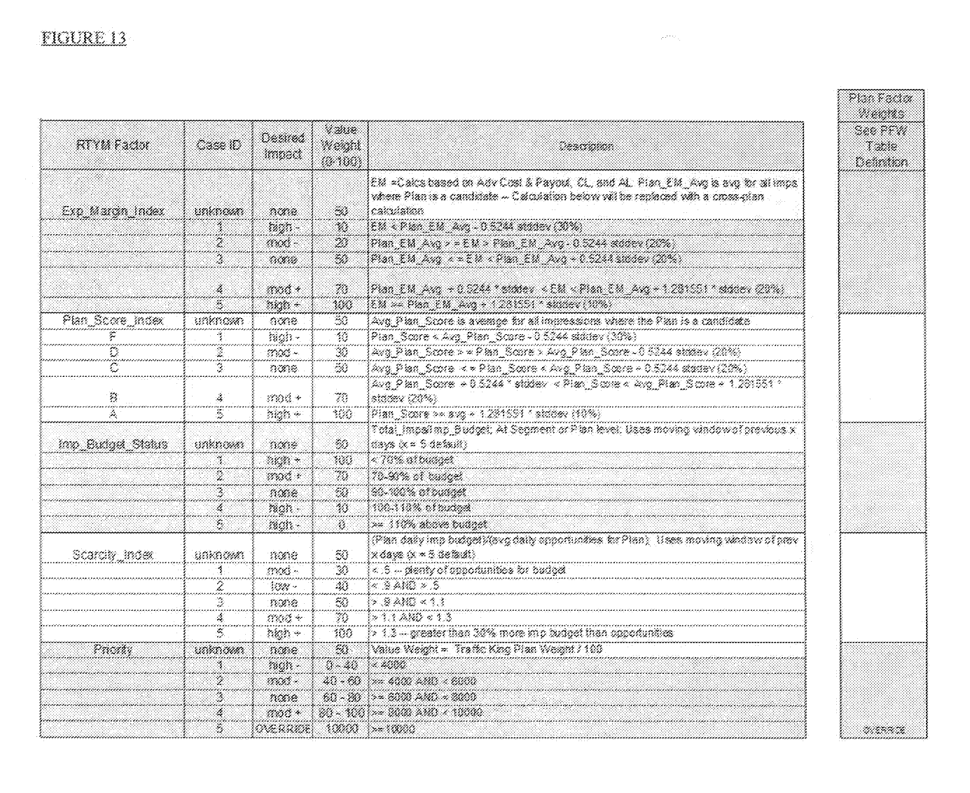

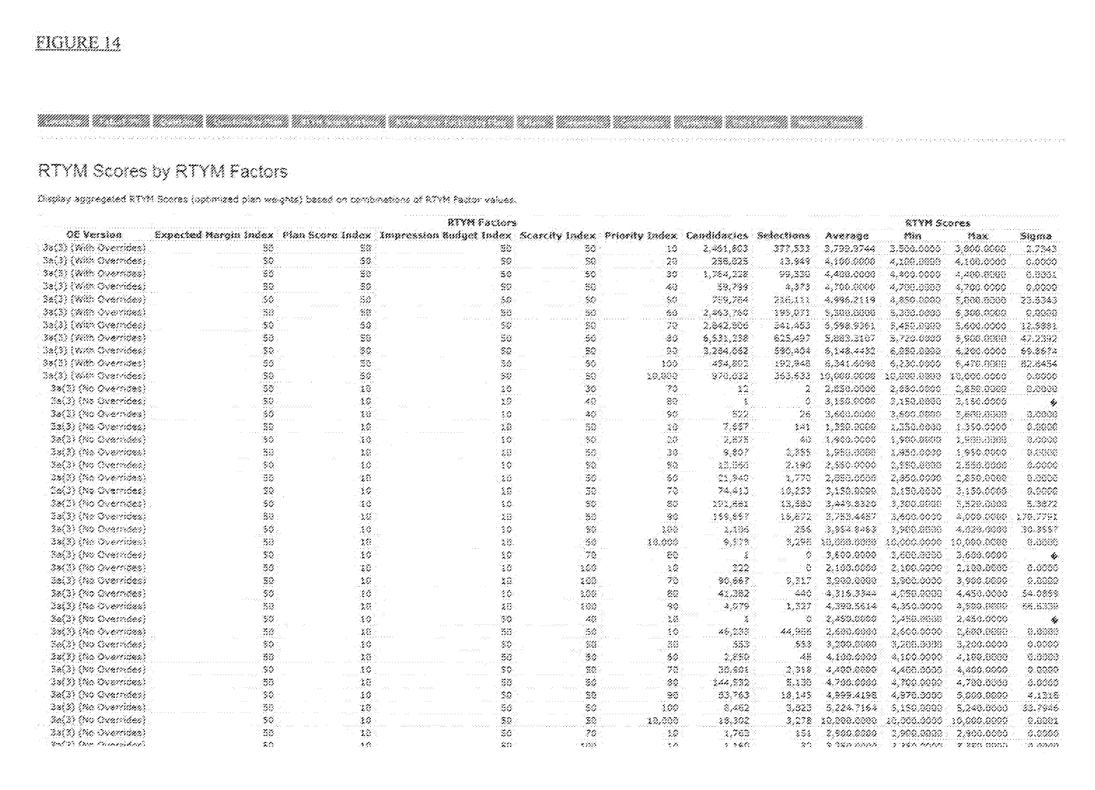

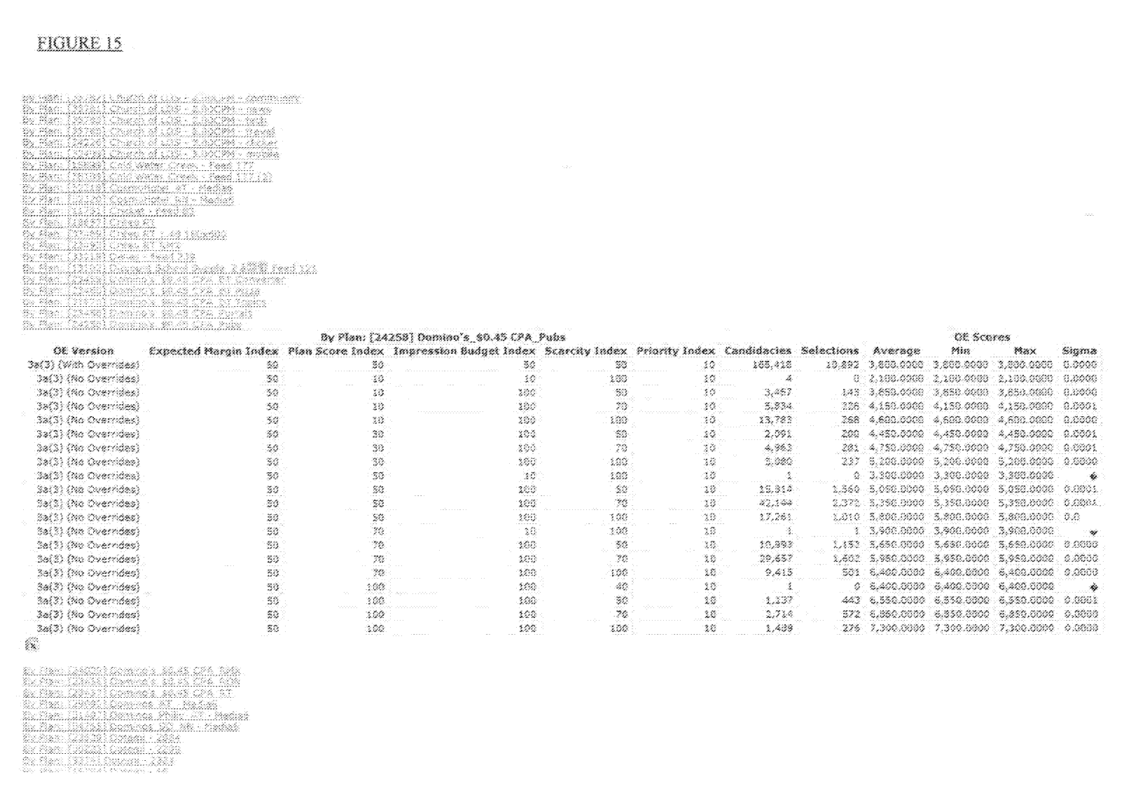

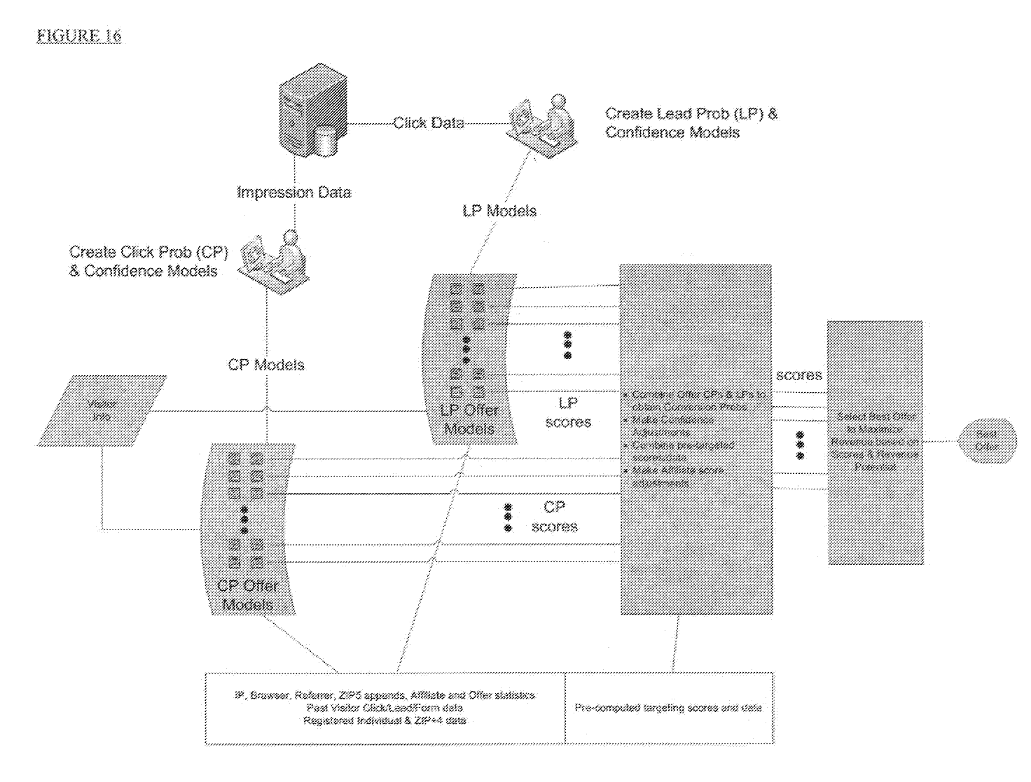

The optimization engine 120 may also execute a real-time yield management (RTYM) process or algorithm in connection with potentially modifying the plans 08 to account for factors such as expected margin, scarcity, budget, or priority, among other yield management data. The RTYM process may determine random control and optimization engine 120 version percentages and may employ an algorithm to adjust weights for the candidate plans 118 to maximize overall revenue, for example, or another suitable output variable. Other factors that may be processed by the optimization engine 120 include plan scores (e.g., CLs and ALs) and confidence levels; expected margin; plan goal, status and achievability assessment; plan priority; impression volume status with respect to minimax; publisher goal status; test objectives or opportunities; and/or model type or confidence. It can be seen that algorithms may be employed within the engine 120 to adjust the candidate plan 118 weights in an effort to maximize overall margin, advertiser, and/or publisher satisfaction within the predefined constraints 114 of the plans 118. FIG. 12 includes a table illustrating examples of plan factor weights that can be used in association with applying weights to various candidate plans 118. For example, the plan factor weights may be applied to each RTYM factor for each Plan_ID. In certain embodiments, the system 102 can be programmed to override or remove a value for a given factor for a given plan 118. For example, expected margin may be overridden for certain candidate plans 118 being analyzed. The processing performed by the optimization engine 120 may be configured to process various data obtained from the data sources described above and return a score for each candidate plan 118. In addition, new weights may be calculated for the plans 118. FIG. 13 illustrates an example of an RTYM process score computation. FIG. 14 illustrates examples of RTYM scores by RTYM factors. FIG. 15 illustrates examples of RTYM score factors by plan.

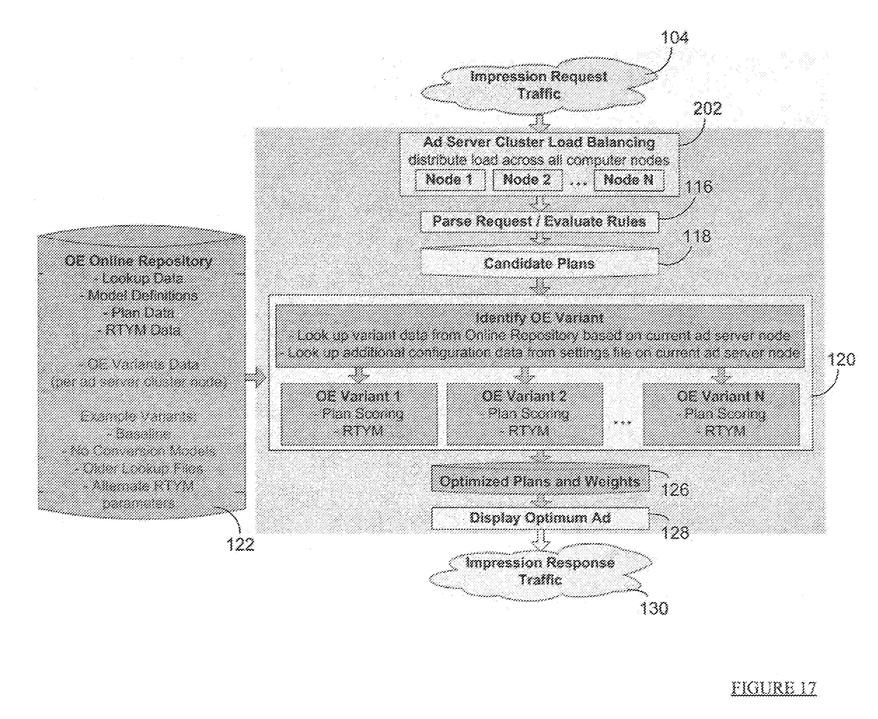

FIG. 16 schematically illustrates one example of a process and system architecture for scoring an offer or plan 118. In this example (and consistent with the aspects of the invention described above), data such as process referrer string, user agent string (e.g., browser string), data, time, and other available data can be combined with append data from pre-computed data tables (e.g., offer stats, publisher stats, ZIPS data, demographics, or derived appends) to generate models. For example, click probability (CP) models and/or lead probability models (LP) can be applied to score each offer or plan 118. The RYTM process may then be applied in connection with delivering an optimum advertisement or offer to a consumer. As noted above, the revenue management and selection strategy has the objective of selecting the best offer for each impression that maximizes achievement of the overall objective (e.g., maximizing revenue), within the defined constraints 114.

The optimization engine 120 may then output one or more optimized plans 126 with updated weights based on processing the data and applying the statistical models and/or algorithms. The selected advertisements may then be communicated or delivered to one or more consumers as impression response traffic 130, as shown in FIG. 1A, such as through an advertisement server, or another suitable content delivery system. In addition, data associated with how consumers react or behave in response to the advertisement may be fed back to the system 102 in the form of new impression request traffic related data 104.

FIG. 17 illustrates an example of how multiple variants or different versions of plans 118 can be processed through the optimization engine 120 for comparison or testing purposes, for example. As shown, the optimization engine 120 may retrieve data from the online repository 122 related to variables that are to be different among the different variants of the plan 118. The variants of the plans 118 may then be scored and processed in parallel and in substantial accordance with the processing described above with respect to FIGS. 1A and 1B. Data regarding how consumers react or behave in response to the different variant plans 118 can be collected and analyzed to understand how each variant plan 118 performed.

With reference again to FIGS. 1A and 1B, it can be seen that the optimization system 102 provides online model development processes that can be used to continuously regenerate, update, or execute multiple plan models and perform automated validation checks prior to implementation. The model data update processes can also be programmed to update the operational data used by the models. Several examples of these operational data include the probability that visitors will click and/or convert for each plan based on past impressions of the plans on the given website; probability that users within a given ZIP Code will click and/or convert on plans within each of the major categories (e.g., dating, games, finance); or, probability that a user will click and/or convert on a plan given the referring source domain. It can be appreciated that the optimization engine 120 may use impression-based and/or precomputed factors or data. As noted above, the repository updater 124 can leverage the volume of data in the enterprise warehouse 106 by precomputing key factors and statistics for use in the online models, providing an enhanced breadth and quality of factors and data that can be made available at the time of plan scoring. In various embodiments, the invention offers automated data processing, factor selection, model development, model validation, and model deployment. It can be further appreciated that embodiments of the invention can provide a “black box” modular implementation in which the optimization engine 120 can be incrementally enhanced in a cost-effective and rapid manner and readily integrated into advertising servers and RTB platforms. Likewise, the repository updater 124 can be programmed to be agnostic to source systems, making it relatively straight forward to change or add new factors, data elements, and/or structures.

In various embodiments, a yield management control center (“YMCC”) 142 may be configured to operate in connection with the optimization engine 120, among other components of the optimization system 102. The YMCC 142 may include a variety of reports and analyses that can be used by the campaign managers 108, 110 to maximize profit, advertiser success, and publisher satisfaction. The YMCC 142 may be programmed to perform advanced analyses based on data mining algorithms, for example, and can recommend alternative criteria or plans. It can be appreciated that the YMCC provides an interface for capitalizing on human intelligence and the experience of the campaign managers 108, 110. In a function substantially similar to the function performed by the repository updater 124, the YMCC 142 may employ one or more data preprocessing routines to prepare data for rapid report availability. In various embodiments, the YMCC 142 can provide “push-button” type analyses versus ad-hoc analyses and can be used to incrementally develop automated analyses.

In various embodiments, the YMCC 142 can be configured to propose alternatives based on rules and by looking beyond the constraints currently imposed within different plans. For example, the YMCC 142 can help the campaign managers 108, 110 to address what other publishers, ZIP data, demographics, topics, or other data might work well; or what combination of variables would facilitate refining a given plan. For example, targeting a certain income level within a set of specific ZIP codes may allow workable solutions with a given publisher. In certain embodiments, the analysis tools of the YMCC 142 may employ decision tree logic, for example. Also, the YMCC 142 may be programmed with a test planner function that can generate test impressions on the network to conduct various analyses and make recommendations based on those analyses. In certain embodiments, the YMCC 142 may include a plan assessment tool that can be used to generate what-if scenarios. For example, the plan assessment tool can consider the situation in which a CPA value is raised and how that might affect the ability to deliver advertising at an expected margin. An auto yield management planner can be provided that proposes new plans for campaign managers 108, 110 to consider or revise prior to implementation. The plans may be revised based on the performance of existing plans, and/or based on criteria specified by the campaign managers 108, 110. For example, ZIP codes, spots, topics most associated with a given set of demographic criteria can be identified. In another example, for a set of users meeting specific criteria based on their cookie topic data, a model can be created for those users for which that topic data is not known.

In various embodiments, the YMCC 142 may provide a plan profiler dashboard that provides information on the relative importance of different factors for a given plan. The plan profiler dashboard may be accompanied by mosaic, bar and pie charts, along with decision-tree based reports. Plan assessment reports can be generated by the YMCC 142 that predict margin, impression volume, and/or eCPA based on targeting constraints. In another example, advertiser look-alike profiles can be generated that identify the characteristics of consumers most likely to click and convert for a given set of advertisements with respect to demographics, site categories, timing and other factors, which can be based on differences among visitors with respect to specified sites and the general user population. Plan achievability may be assessed by the YMCC 142, including plans for which goals cannot be achieved or that could exceed goals with an increased budget (e.g., with an estimated increase in budget). The YMCC 142 may also be programmed to generate one or more trend reports (e.g., plans with CTR trending lower or higher). In addition, in certain embodiments the YMCC 142 may be programmed to analyze audience segments and clusters that segment users based on intent, behavioral, and/or demographic/psychographic data.

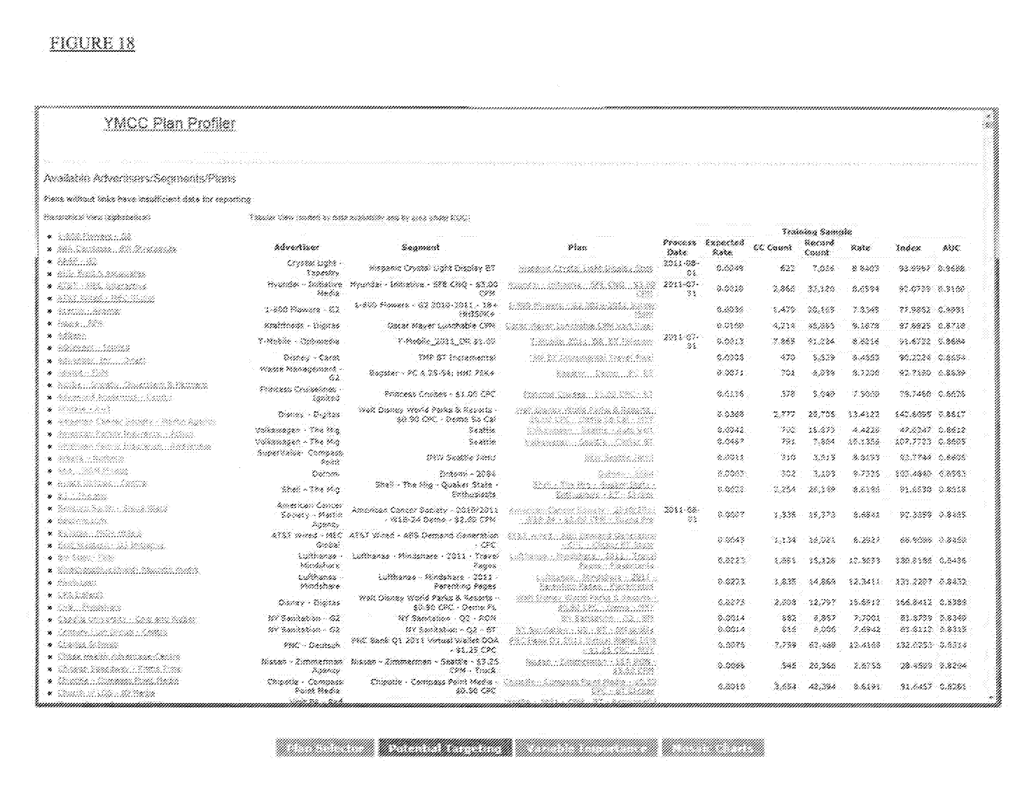

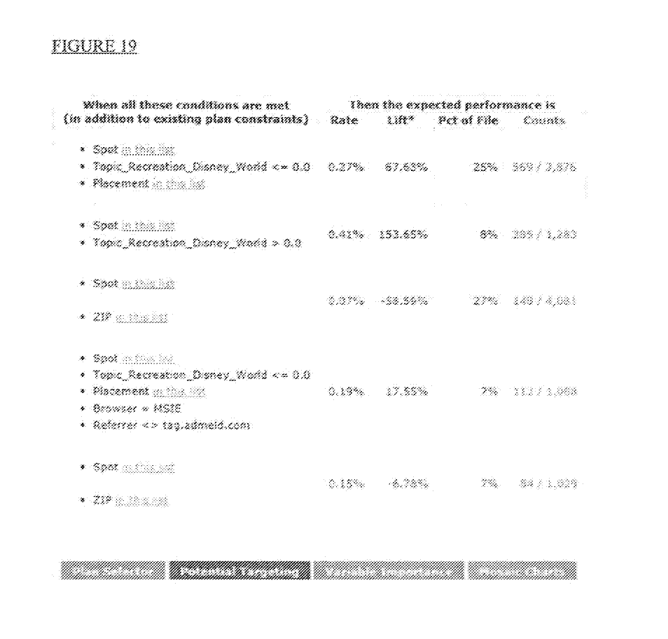

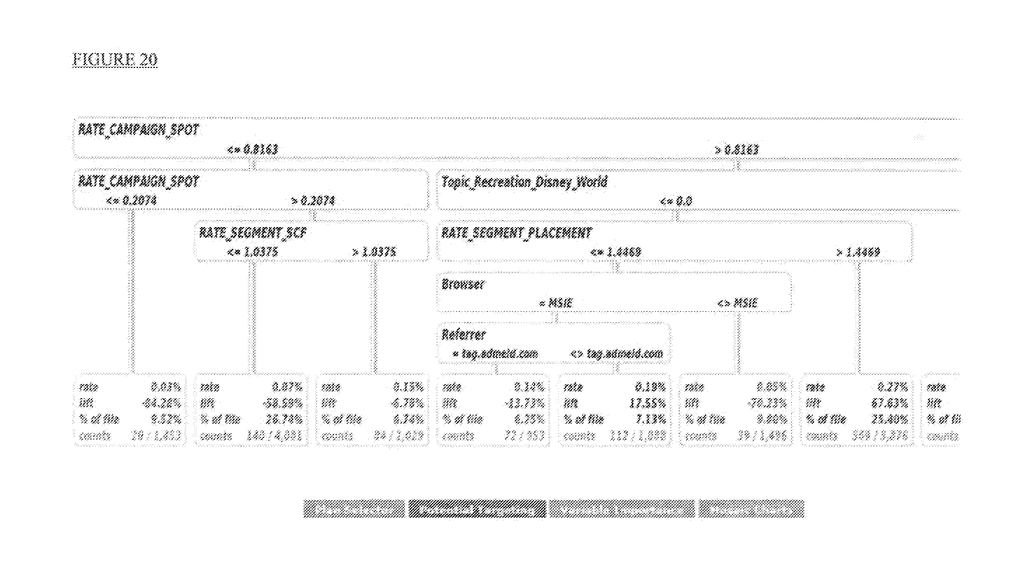

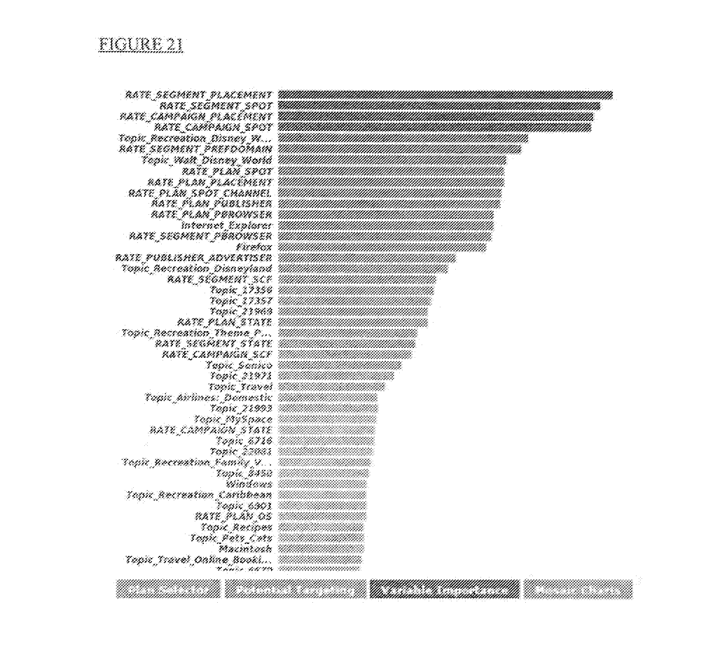

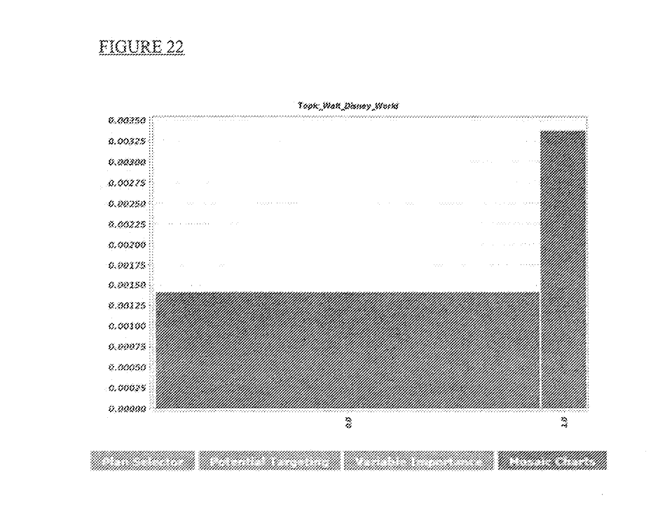

A plan profiler tool may be provided in association with the YMCC 142 to help the campaign managers 108, 110 identify potential new targeting rules, to learn which factors are impacting plan 118 or strategy performance, to identify useful combinations of multiple factors versus the impact of single factors on clicks and conversions, to illustrate the relative importance of comprehensive set of factors, and/or to assist with automating development of proposed new plans 118 or strategies. FIG. 18 includes an example of a plan profiler report or dashboard illustrating various available advertisers, segments, and plans. The example of a potential targeting screen shown in FIG. 19 identifies combinations of factors and their corresponding impact on click and conversion rates. FIG. 20 illustrates an example of a decision tree that may be converted into tabular form in connection with the plan profiler tool. FIG. 21 illustrates an example of a variable importance screen that can rank order factors based on their correlation to click and conversion rates. FIG. 22 illustrates an example of a mosaic chart screen demonstrating the relationship between individual factor values and click and conversion rates. In this example, the width of a bar reflects the frequency of a factor value, and the height of a bar reflects the click or conversion rate for a factor value. In this example, there is a higher click or conversion rate for users with this topic in their cookies, but there are relatively fewer such users in the overall population.

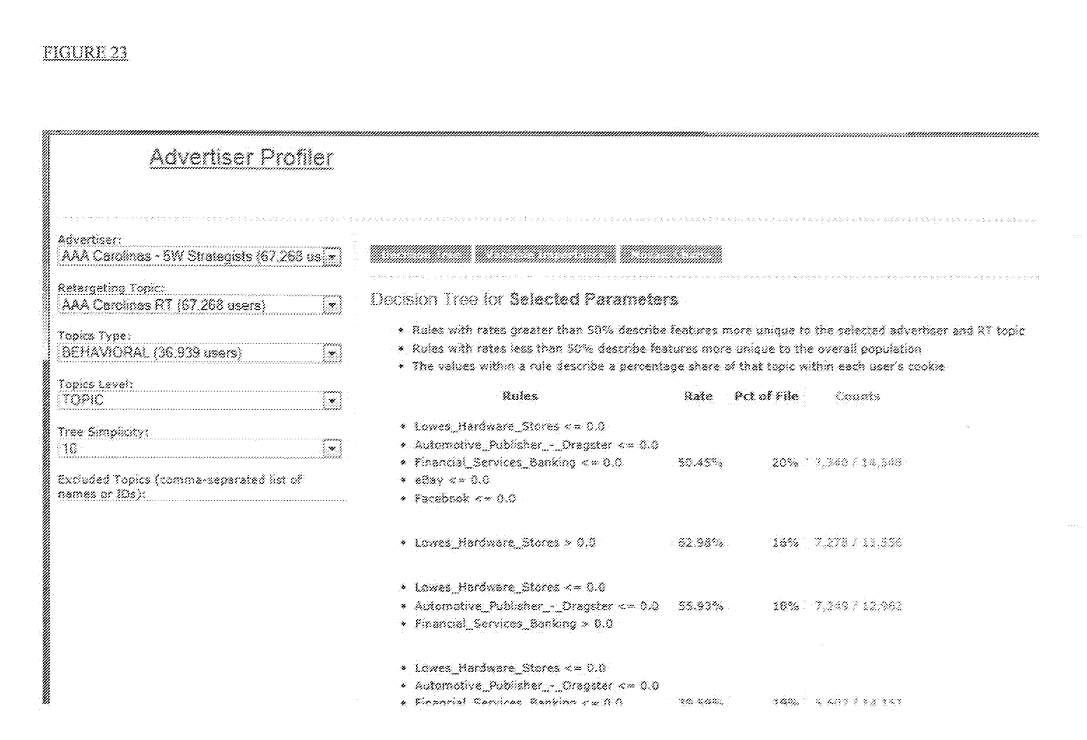

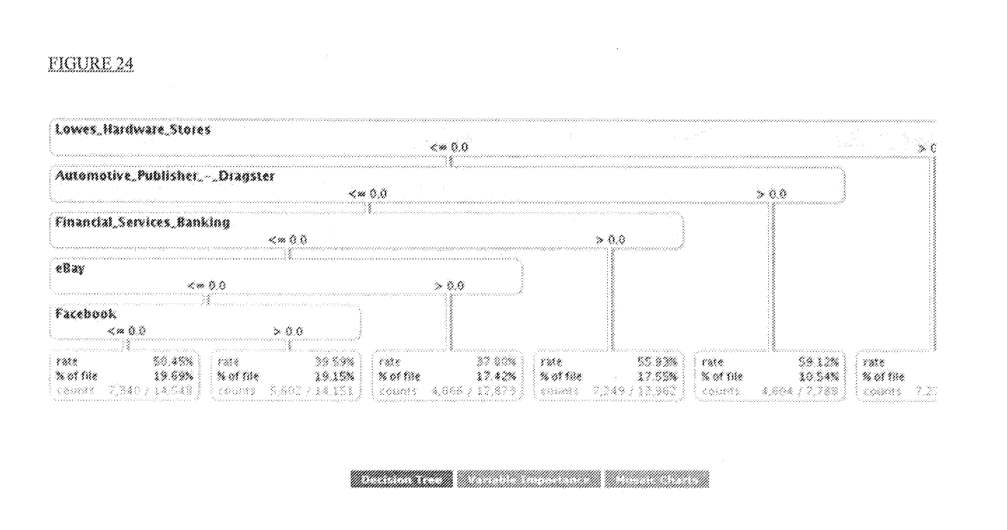

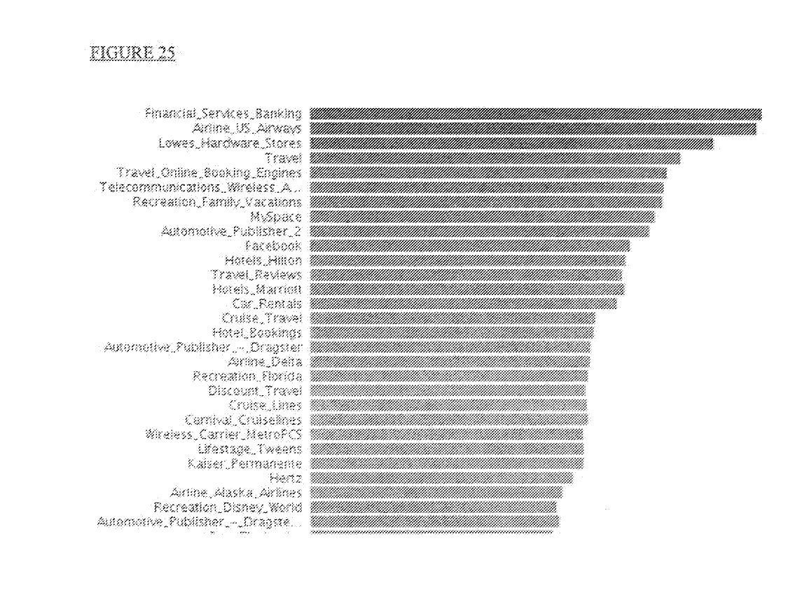

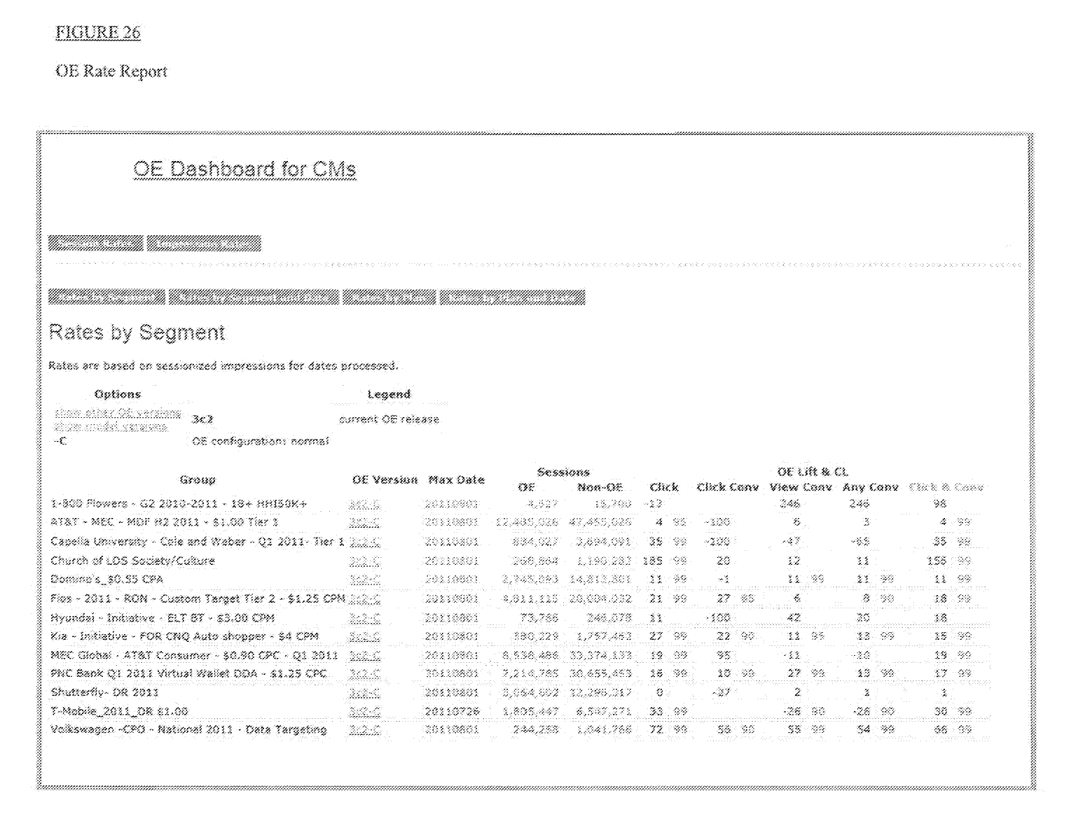

An advertiser profiler tool may be provided in association with the YMCC 142 to allow each advertiser with a retargeting topic to identify topics that may differentiate the advertiser from the overall TMP user population. FIG. 23 includes an example of an advertiser profiler report in which a campaign manager 108, 110 can select advertiser, retargeting topic, and analysis level (e.g., topic, category, or category group), as well as specify other parameters. In the example shown in FIG. 24, a decision tree screen shows combinations of topics and whether the topics are more unique to the advertiser or more unique to the common population and by what percentage (a topic of “<=0.0” reflects users without the given topic in their cookies). In another example shown in FIG. 25, a variable importance screen demonstrates, for each topic in users' cookies, the correlation between users with that topic and users with the selected retargeting topic.

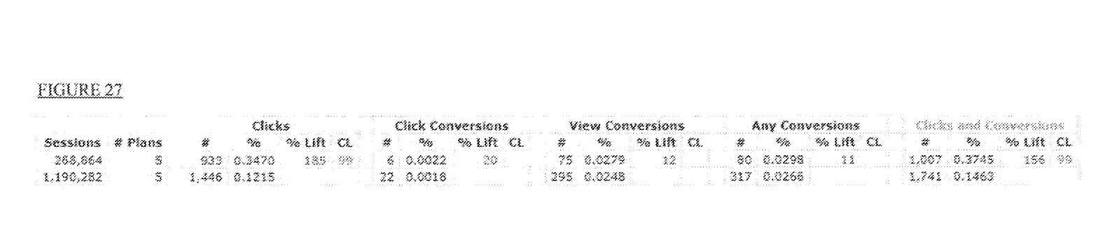

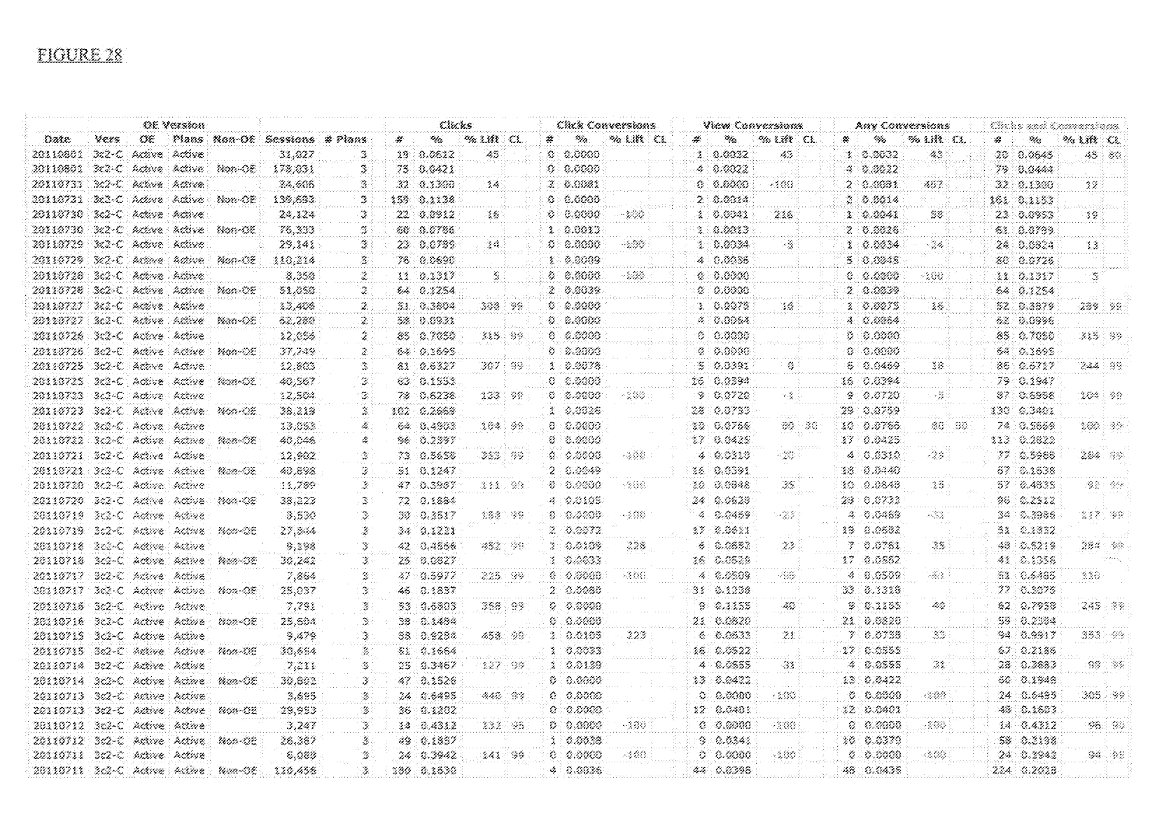

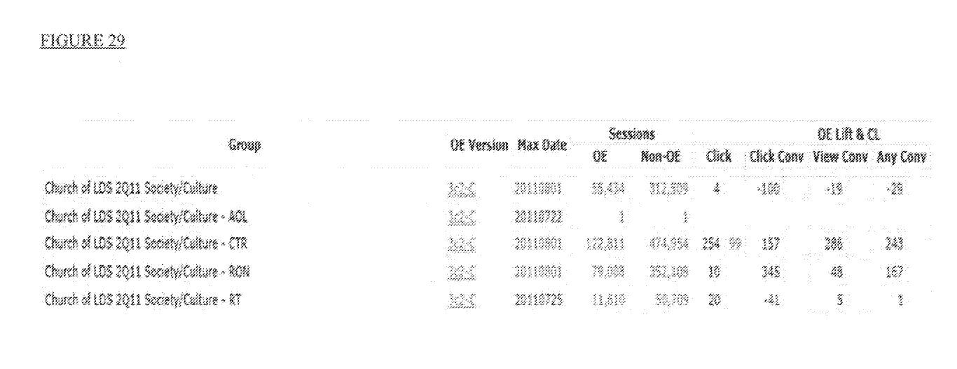

Examples of various OE rates report that may be generated with the YMCC 142 are illustrated in FIGS. 27 through 30. In these examples, the rates report reflect a goal of optimizing clicks or conversions, and data are shown for selected segments from Jul. 6, 2011 through Aug. 21, 2011. A percentage lift is provided to illustrate improvement optimized rates versus rates not optimized using the optimization engine 120. Statistical confidence levels are also shown for various rates. These figures also illustrate drilling down into an individual segment or plan 118 to see rates with and without involvement of the optimization engine 120. In various aspects of this example, “Church of LDS Society/Culture” is shown, including various OE data and non-OE data.

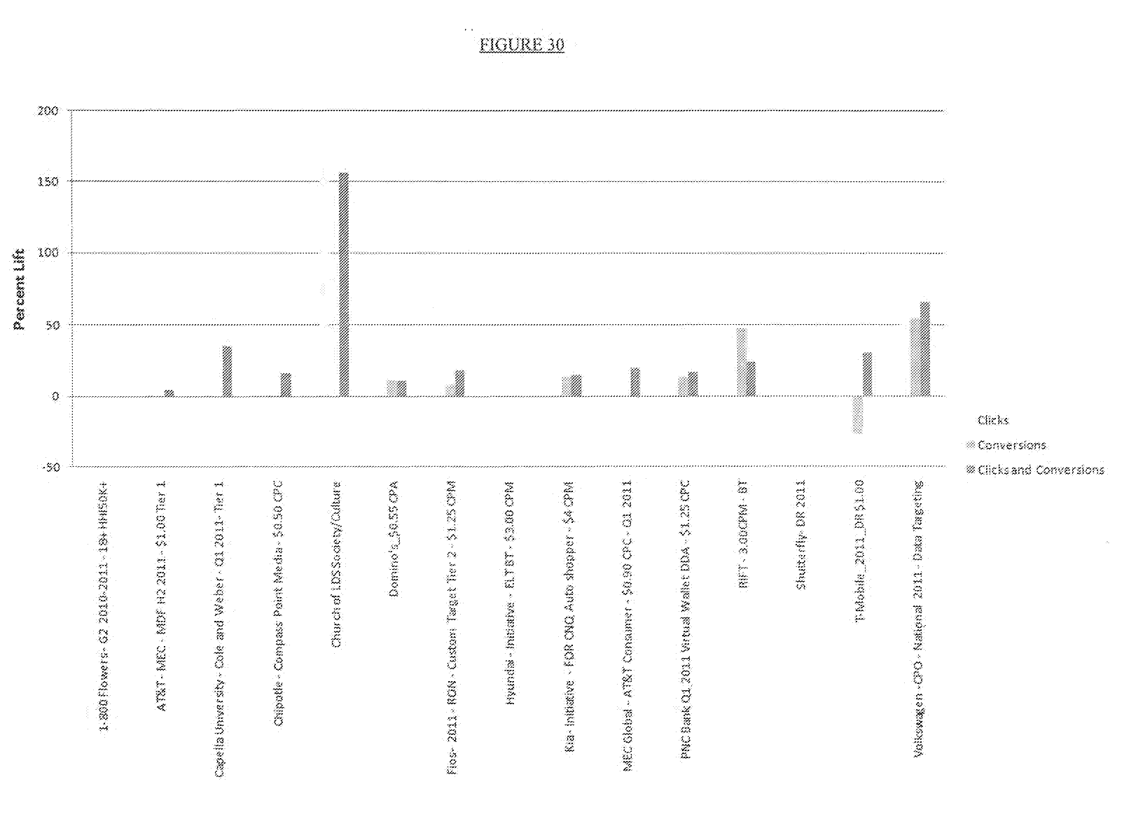

FIG. 30 illustrates a summary of results associated with a performance assessment for the optimization engine 120. In this example, the optimization engine 120 has been evaluated versus non-use of the optimization engine 120 for 15 segments (191 plans) for a predetermined period. With use of the optimization engine 102, it can be seen that of the 11 segments having statistically significant clicks: 100% had higher click rates of 5% to 186% with an average increase of 40%. Of 7 segments having statistically significant conversions: 6 of the 7 had higher conversion rates of 8 to 55% with an average increase of 23%. Also, T Mobile had a 27% decrease in conversions with 33% increase in clicks. Of the 12 segments having significant clicks and converts: 100% had higher click and convert rates of 5% to 156%, with an average increase of 34%.

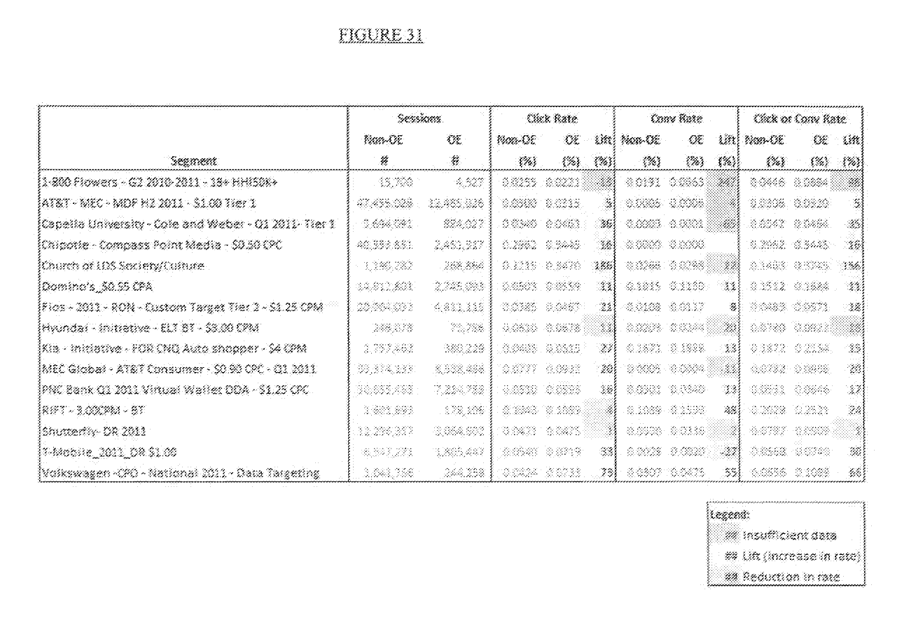

FIG. 31 illustrates examples of performance details for the optimization engine 120. The results indicate the optimization engine 120 substantially increases click and conversion rates. In this example, the RTYM process did not weight plans 118 relative to others, but relative to prediction of plan 118 performance versus an average rate. Use of the RTYM process improved click and conversion rates without allowing best plans 118 to dominate, i.e., maintaining a relative number of impressions across plans 118. In this example, most of the plans 118 used models to maximize “clicks and conversions” because of a lack of sufficient conversion data; however, conversion rates can be improved as more data is made available.

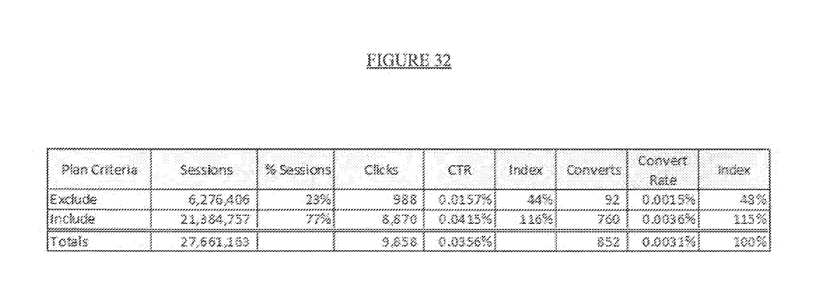

FIG. 32 illustrates an example of a report that can be generated when a campaign manager 108, 110 speculates a set of rules to see expected rates, lift and opportunity, or data as shown.

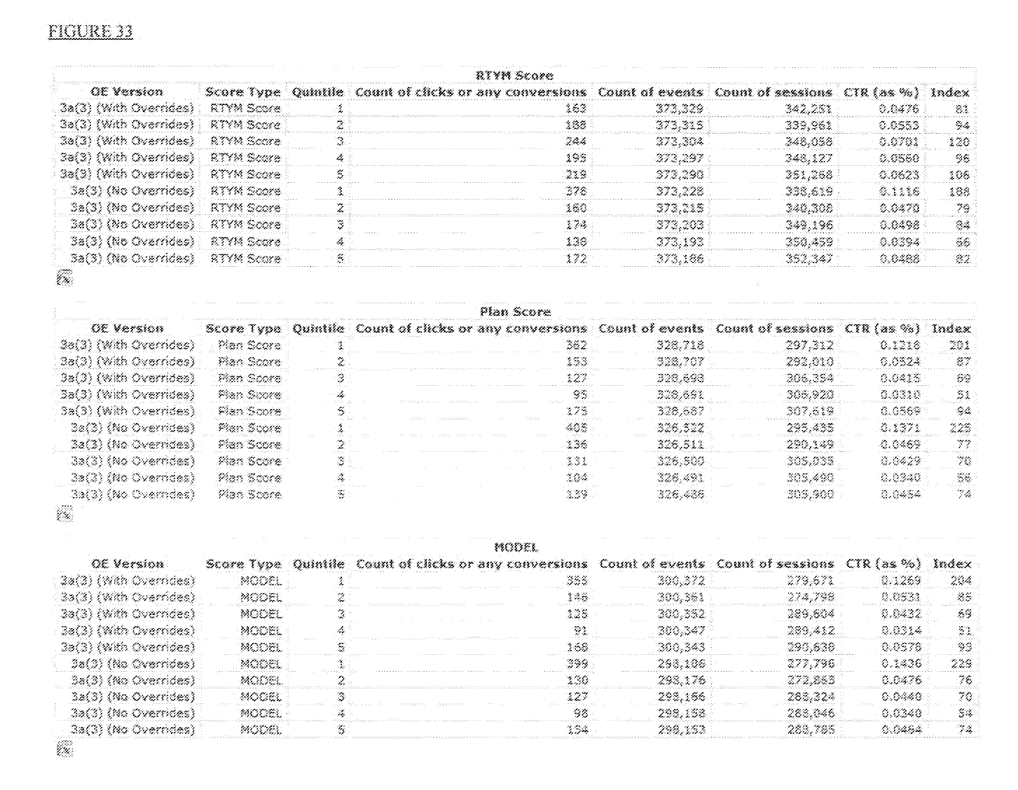

FIG. 33 illustrates an example of a model quintile report that can be generated to monitor optimization engine 120 health and/or to evaluate the optimization engine 120 in a “passive” mode. In passive mode, the optimization engine 120 logs its behavior without affecting online plan 118 selection.

In various embodiments, one or more kinds of analytic tools 152 may be used in connection with the optimization system 102, the optimization engine 120, and/or the YMCC 142 to perform or assist with data preprocessing, statistical analyses, model development, testing and off-line validation, system monitoring, and/or reporting. Examples of such analytic tools 152 include data preprocessing and analysis routines; SPSS modeler software and other data mining tools; OLAP statistical tools; geographic information system (“GIS”) tools; TMP derived enhancement databases; national consumer database file; automated offline model development routines; automated test and/or validation routines; simulations of online system results; operational performance monitoring systems; and/or reporting systems.

Embodiments of the present invention provide numerous advantages over conventional approaches. Some conventional systems periodically created a decision tree to be used in attempting to determine what content to provide. In contrast, the embodiments of the present invention provide real-time processing of various inputs. In addition, embodiments of the present invention provide many more variables than have been available with conventional approaches to optimizing provided content.

A further advantage of some embodiments of the present invention is the capability of using predictive models to automate the process of optimizing the content that will perform best. Rather than simply apply a statistical approach, such as the historical conversion rate, and continually serving content based on that statistical approach, predictive analytics are applied to help to tease out otherwise unknown variations using a fewer number of impressions to gain a statistically significant sample. In such an embodiment, instead of running, for example, ten million impressions for each variable to determine the statistical effect, a higher number of variables are utilized to obtain the same statistical significance for similar tests running a much smaller number of impressions. Thus, the cost to perform the analysis to determine which content performs at the best rate is significantly less expensive. Further, such determinations of yield optimization can be performed within the context of preexisting rules and constraints.

The examples presented herein are intended to illustrate potential and specific implementations of the present invention. It can be appreciated that the examples are intended primarily for purposes of illustration of the invention for those skilled in the art.

No particular aspect or aspects of the examples are necessarily intended to limit the scope of the present invention. For example, no particular aspect or aspects of the examples of system architectures, user interface layouts, or screen displays described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention. In certain embodiments, a “module” may include software, firmware, hardware, or any reasonable combination thereof.

Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

A “computer,” “computer system,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media. In various embodiments, a “host,” “engine,” “updater,” “loader,” “filter,” “platform,” or “component” may include various computers or computer systems, or may include a reasonable combination of software, firmware, and/or hardware.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described hereinabove may be implemented in computer software using any suitable computer programming language such as .NET, SQL, MySQL, or HTML using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Various embodiments may be employed in a Lotus Notes environment, for example. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

For example, a WAN computer network may cover a broad area by linking communications across metropolitan, regional, or national boundaries. The network may use routers and/or public communication links. One type of data communication network may cover a relatively broad geographic area (e.g., city-to-city or country-to- country) which uses transmission facilities provided by common carriers, such as telephone service providers. In another example, a GAN computer network may support mobile communications across multiple wireless LANs or satellite networks. In another example, a VPN computer network may include links between nodes carried by open connections or virtual circuits in another network (e.g., the Internet) instead of by physical wires. The link-layer protocols of the VPN can be tunneled through the other network. One VPN application can promote secure communications through the Internet. The VPN can also be used to separately and securely conduct the traffic of different user communities over an underlying network. The VPN may provide users with the virtual experience of accessing the network through an IP address location other than the actual IP address which connects the access device to the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods and systems described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity. As applied herein, an extranet may include a network or internetwork generally limited to a primary organization or entity, but which also has limited connections to the networks of one or more other trusted organizations or entities (e.g., customers of an entity may be given access an intranet of the entity thereby creating an extranet).

Computer networks may include hardware elements to interconnect network nodes, such as network interface cards (NICs) or Ethernet cards, repeaters, bridges, hubs, switches, routers, and other like components. Such elements may be physically wired for communication and/or data connections may be provided with microwave links (e.g., IEEE 802.12) or fiber optics, for example. A network card, network adapter or NIC can be designed to allow computers to communicate over the computer network by providing physical access to a network and an addressing system through the use of MAC addresses, for example. A repeater can be embodied as an electronic device that receives and retransmits a communicated signal at a boosted power level to allow the signal to cover a telecommunication distance with reduced degradation. A network bridge can be configured to connect multiple network segments at the data link layer of a computer network while learning which addresses can be reached through which specific ports of the network. In the network, the bridge may associate a port with an address and then send traffic for that address only to that port. In various embodiments, local bridges may be employed to directly connect local area networks (LANs); remote bridges can be used to create a wide area network (WAN) link between LANs; and/or, wireless bridges can be used to connect LANs and/or to connect remote stations to LANs.

In various embodiments, a hub may be employed which contains multiple ports. For example, when a data packet arrives at one port of a hub, the packet can be copied unmodified to all ports of the hub for transmission. A network switch or other devices that forward and filter OSI layer 2 datagrams between ports based on MAC addresses in data packets can also be used. A switch can possess multiple ports, such that most of the network is connected directly to the switch, or another switch that is in turn connected to a switch. The term “switch” can also include routers and bridges, as well as other devices that distribute data traffic by application content (e.g., a Web URL identifier). Switches may operate at one or more OSI model layers, including physical, data link, network, or transport (i.e., end-to-end). A device that operates simultaneously at more than one of these layers can be considered a multilayer switch. In certain embodiments, routers or other like networking devices may be used to forward data packets between networks using headers and forwarding tables to determine an optimum path through which to transmit the packets.

As employed herein, an application server may be a server that hosts an API to expose business logic and business processes for use by other applications. Examples of application servers include J2EE or Java EE 5 application servers including WebSphere Application Server. Other examples include WebSphere Application Server Community Edition (IBM), Sybase Enterprise Application Server (Sybase Inc.), WebLogic Server (BEA), JBoss (Red Hat), JRun (Adobe Systems), Apache Geronimo (Apache Software Foundation), Oracle OC4J (Oracle Corporation), Sun Java System Application Server (Sun Microsystems), and SAP Netweaver AS (ABAP/Java). Also, application servers may be provided in accordance with the .NET framework, including the Windows Communication Foundation, .NET Remoting, ADO.NET, and ASP.NET among several other components. For example, a Java Server Page (JSP) is a servlet that executes in a web container which is functionally equivalent to CGI scripts. JSPs can be used to create HTML pages by embedding references to the server logic within the page. The application servers may mainly serve web-based applications, while other servers can perform as session initiation protocol servers, for instance, or work with telephony networks. Specifications for enterprise application integration and service-oriented architecture can be designed to connect many different computer network elements. Such specifications include Business Application Programming Interface, Web Services Interoperability, and Java EE Connector Architecture.

In various embodiments, computers and computer systems described herein may have the following main components: arithmetic and logic unit (ALU), control unit, memory, and input and output devices (VO devices). These components can be interconnected by busses, often comprising groups of wires or cables. The control unit, ALU, registers, and basic VO (and often other hardware closely linked with these sections) can be collectively considered a central processing unit (CPU) for the computer system. The CPU may be constructed on a single integrated circuit or microprocessor.

The control unit (control system or central controller) directs the various components of a computer system. The control system decodes each instruction in a computer program and turns it into a series of control signals that operate other components of the computer system. To enhance performance or efficiency of operation, the control system may alter the order of instructions. One component of the control unit is the program counter, a memory register that tracks the location in memory from which the next instruction is to be read.

The ALU is capable of performing arithmetic and logic operations. The set of arithmetic operations that a particular ALU supports may be limited to adding and subtracting or might include multiplying or dividing, trigonometry functions (sine, cosine, etc.) and square roots. Some may be programmed to operate on whole numbers (integers), while others use floating point to represent real numbers, for example. An ALU may also compare numbers and return Boolean truth values (e.g., true or false). Superscalar computers may contain multiple ALUs to facilitate processing multiple instructions at the same time. For example, graphics processors and computers with SIMD and MIMD features often possess ALUs that can perform arithmetic operations on vectors and matrices. Certain computer systems may include one or more RAM cache memories configured to move more frequently needed data into the cache automatically.

Examples of peripherals that may be used in connection with certain embodiments of the invention include input/output devices such as keyboards, mice, screen displays, monitors, printers, hard disk drives, floppy disk drives, joysticks, and image scanners.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

In various embodiments, the computer systems, data storage media, or modules described herein may be configured and/or programmed to include one or more of the above-described electronic, computer-based elements and components, or computer architecture. In addition, these elements and components may be particularly configured to execute the various rules, algorithms, programs, processes, and method steps described herein.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

What is claimed is:

1. A method for identifying at least one piece of content to communicate to a consumer, the method comprising:
receiving impression request data associated with at least one consumer accessing a networked medium in a computing environment;
employing a parse request module to evaluate at least one campaign constraint to generate one or more candidate plans, wherein each of the one or more candidate plans includes at least one variable having an associated weight and at least one campaign constraint;
employing an optimization engine to determine a first score for each of the one or more candidate plans using a model, wherein the model utilizes at least a portion of precomputed data and a portion of the impression request data;
employing the optimization engine for applying at least one real-time yield management algorithm to evaluate the at least one variable and at least one campaign constraint to develop a second score for each of the one or more candidate plans; and
identifying at least one optimum plan based on the first score and the second score.

2. The method of claim 1, where receiving the impression request data includes receiving data associated with a browser of the consumer.

3. The method of claim 1, wherein using a model includes using input data derived from an enterprise data warehouse.

4. The method of claim 1, further comprising receiving data in the optimization engine from an online repository operatively associated with an enterprise data warehouse.

5. The method of claim 4, further comprising receiving precomputed data or statistics from at least one look-up table associated with the online repository.

6. The method of claim 4, further comprising using the model in association with a logistic regression analysis or a neural network.

7. The method of claim 4, further comprising performing at least one automatic data update or automatic model update with a repository updater operatively associated with the online repository.

8. The method of claim 1, further comprising operatively associating a yield management control center with the optimization engine.

9. The method of claim 8, further comprising generating at least one report with the yield management control center in response to operation of the optimization engine.

10. The method of claim 1, further comprising using the optimization engine for processing multiple variants of each of the one or more candidate plans in parallel.

11. A system for identifying at least one piece of content to communicate to a consumer, the system comprising:
a processor programmed for receiving impression request data associated with at least one consumer accessing a networked medium in a computing environment;
a processor programmed for employing a parse request module to evaluate at least one campaign constraints to generate one or more candidate plans, wherein each of the one or more candidate plans includes at least one variable having an associated weight and at least one campaign constraint;
a processor programmed for employing an optimization engine to determine a first score for each of the one or more candidate plans using a model, wherein the model utilizes at least a portion of precomputed data and a portion of the impression request data;
a processor programmed for employing the optimization engine for applying at least one real-time yield management algorithm to evaluate the at least one variable and at least one campaign constraint to develop a second score for each of the one or more candidate plans; and
a processor programmed for identifying at least one optimum plan based on the first score and the second score.

12. The system of claim 11, wherein the processor programmed for receiving the impression request data includes instructions for receiving data associated with a browser of the consumer.

13. The system of claim 11, wherein the optimization engine is further programmed for using input data derived from an enterprise data warehouse for scoring each of the plans using the model.

14. The system of claim 11, further comprising an online repository operatively associated with the optimization engine, wherein the online repository is further operatively associated with a data warehouse and the optimization engine is further programmed to receive data from the online repository.

15. The system of claim 14, wherein the optimization engine is further programmed to receive precomputed data or statistics from at least one look-up table associated with the online repository.

16. The system of claim 14, wherein the optimization engine is further programmed for using the model in association with a logistic regression analysis or a neural network.

17. The system of claim 14, further comprising a repository updater operatively associated with the online repository, wherein the repository updater is programmed for performing at least one automatic data update or automatic model update.

18. The system of claim 11, further comprising a yield management control center operatively associated with the optimization engine.

19. The system of claim 18, wherein the yield management control center is programmed to generate at least one report in response to operation of the optimization engine.

20. The system of claim 11, wherein the optimization engine is further programmed for processing multiple variants of each of the at least one candidate plans in parallel.
